(19) United States
(12) Patent Application Publication
(10) Pub. No.: US 2005/0096880 A1
(43) Pub. Date: May 5, 2005

(54) Inverse model calculation apparatus and inverse model calculation method

(75) Inventors: Chie Morita, Kanagawa-Ken (JP); Hisaaki Hatano, Kanagawa-Ken (JP); Akihiko Nakase, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/930,766

(22) Filed: Sep. 1, 2004

(30) Foreign Application Priority Data
Sep. 2, 2003 (JP) 2003-310368
Jan. 28, 2004 (JP) 2004- 19552
Aug. 10, 2004 (JP) 2004-233503

(51) Int. Cl. G21C 17/00; G06F 15/00; G06F 11/30; G06F 17/00; G06N 5/02

(52) U.S. Cl. 702/189; 706/46; 702/182

(57) ABSTRACT

An inverse model calculation apparatus and method according to an embodiment of the present invention record an input value inputted sequentially to a target system and an output value outputted sequentially from the target system as time series data, generate a decision tree for inferring an output value at future time, using the time series data, detect a leaf node having an output value at future time as a value of an object variable from the decision tree, and acquire a condition of explaining variables included in a rule associated with a path from a root node of the decision tree to the detected leaf node, as a condition for obtaining the output value.

### CROSS-REFERENCE TO RELATED APPLICATIONS

This application claims the benefit of priority under 35USC §119 to Japanese Patent Application No. 2003-310368 filed on Sep. 2, 2003, No. 2004-19552 filed on Jan. 28, 2004, and No. 2004-233503 filed on Aug. 10, 2004, the entire contents of which are incorporated herein by reference.

### BACKGROUND OF THE INVENTION

1. Field of the Invention

The present invention relates to an inverse model calculation apparatus and an inverse model calculation method.

2. Background Art

It is one of problems demanded in the field of control or the like to find an input required to obtain a desirable output from an object system (inverse calculation). If physical characteristics of the object system are already obtained as a numerical expression, the input can be found by solving the numerical expression.

In many cases, however, the numerical expression is not obtained beforehand. In the case where the numerical expression is not obtained beforehand, typically a mathematical model representing characteristics of the object system is constructed by using data obtained by observing the object system.

Typically, a forward model used to find an output obtained when a certain input is given can be constructed easily. However, it is difficult to generate an inverse model used to find an input required to obtain a certain output. The reason is that there are a plurality of inputs for which the same output is obtained.

Therefore, it is frequently performed to first construct a forward model, and estimate an input from an output by using the forward model. In such a case, a method using a generalized inverse matrix of a linear model, a method of performing an inverse calculation using a neural net, a solution by using simulation, and so on have heretofore been used.

However, the method using the generalized inverse matrix of a linear model becomes poor in calculation precision in the case where the nonlinearity of the object system is strong or in the case of multi-input and a single output.

On the other hand, in the inverse calculation using a neural net, all input variables used to construct the forward model of the neural net become the calculation object, and consequently even an unnecessary input is identified, and it is difficult to find an optimum input. Furthermore, in the inverse calculation using the neural net, it is difficult to calculate after how many time units the given output is obtained.

The solution using simulation is a method of giving various inputs to a forward model and determining whether a target output is obtained in a cut and try manner. Therefore, a large quantity of calculation is needed, and consequently it takes a long time to perform the calculation.

### SUMMARY OF THE INVENTION

In order to solve the above-described problem, the present invention provides an inverse model calculation apparatus and an inverse model calculation method capable of efficiently calculating an input condition required to obtain a desired output.

An inverse model calculation apparatus according to an embodiment of the present invention provides an inverse model calculation apparatus for finding a condition under which a target system outputs a certain output value, the target system outputting the certain output value on the basis of an input value to the target system, the inverse model calculation apparatus comprising: a time series data recording section which records an input value inputted sequentially to the target system and an output value outputted sequentially from the target system as time series data; a decision tree generation section which generates a decision tree for inferring an output value at future time, using the time series data; and a condition acquisition section which detects a leaf node having an output value at future time as a value of an object variable from the decision tree, and acquires a condition of explaining variables included in a rule associated with a path from a root node of the decision tree to the detected leaf node, as a condition for obtaining the output value.

An inverse model calculation apparatus according to an embodiment of the present invention provides an inverse model calculation apparatus for finding a condition under which a target system outputs a certain output value, the target system outputting the certain output value on the basis of an input value to the target system, the inverse model calculation apparatus comprising: a time series data recording section which records an input value inputted sequentially to the target system and an output value outputted sequentially from the target system as time series data; a decision tree generation section which generates a decision tree for inferring an output value at future time, using the time series data; a condition acquisition section which an output value at future time is inputted into as a initial condition, which detects a leaf node having the inputted output value as a value of an object variable from the decision tree, and which acquires a condition of explaining variables included in a rule associated with a path from a root node of the decision tree to the detected leaf node, as a condition to obtain the output value; and a condition decision section, which determines whether the acquired condition is a past condition or a future condition, which determines whether the acquired condition is true or false by using the time series data and the acquired condition in the case where the acquired condition is the past condition, which determines whether the acquired condition is an input condition or an output condition in the case where the acquired condition is the future condition, which outputs the acquired condition as a necessary condition for obtaining the output value in the case where the acquired condition is the input condition, and which outputs the acquired condition to the condition acquisition section as an output value at future time in the case where the acquired condition is the output condition.

An inverse model calculation apparatus according to an embodiment of the present invention provides an inverse model calculation apparatus for finding a condition under which a target system outputs a certain output value, the target system outputting the certain output value on the basis of an input value to the target system, the inverse model calculation apparatus comprising: time series data recording section which records an input value inputted sequentially to the target system and an output value outputted sequentially from the target system as time series data; a decision tree generation section which generates a decision tree for inferring an output value at future time, using the time series data, a path from a root node to a leaf node being associated in the decision tree with a rule including a condition of explaining variables and a value of an object variable; a first rule detection section which detects a rule having an output value at future time as a value of an object variable, from the decision tree; a first condition calculation section which determines whether a condition of explaining variables for a partial time zone in the detected rule matches the time series data, and which in the case of matching, calculates a condition for obtaining the output value at the future time, using the detected rule and the time series data;

a second rule detection section, to which a rule is inputted, and which detects a rule that a condition of explaining variables for a partial time zone in the inputted rule matches from the decision tree; a first input section which inputs the rule detected by the first rule detection section to the second rule detection section, in the case where the rule detected by the first rule detection section does not match the time series data; a second input section which determines whether a condition of explaining variables for a partial time zone in the rule detected by the second rule detection section matches the time series data, and which, in the case of not-matching, inputs the rule detected by the second rule detection section to the second rule detection section; and a second condition calculation section which calculates a condition for obtaining the output value at the future time, using all rules detected by the first and second rule detection sections and the time series data, in the case where the rule detected by the second rule detection section matches the time series data.

An inverse model calculation method according to an embodiment of the present invention provides an inverse model calculation method for finding a condition under which a target system outputs a certain output value, the target system outputting the certain output value on the basis of an input value to the target system, the inverse model calculation method comprising: recording an input value inputted sequentially to the target system and an output value outputted sequentially from the target system as time series data; generating a decision tree for inferring an output value at future time, using the time series data; and detecting a leaf node having an output value at future time as a value of an object variable from the decision tree; and acquiring a condition of explaining variables included in a rule associated with a path from a root node of the decision tree to the detected leaf node, as a condition for obtaining the output value.

An inverse model calculation method for finding a condition under which a target system outputs a certain output value, the target system outputting the certain output value on the basis of an input value to the target system, the inverse model calculation apparatus comprising: recording an input value inputted sequentially to the target system and an output value outputted sequentially from the target system as time series data; generating a decision tree for inferring an output value at future time, using the time series data; inputting an output value at future time as a initial condition; detecting a leaf node having the inputted output value as a value of an object variable from the decision tree; acquiring a condition of explaining variables included in a rule associated with a path from a root node of the decision tree to the detected leaf node, as a condition for obtaining the output value; determining whether the acquired condition is a past condition or a future condition; determining whether the acquired condition is true or false by using the time series data and the acquired condition in the case where the acquired condition is the past condition; determining whether the acquired condition is an input condition or an output condition in the case where the acquired condition is the future condition; outputting the acquired condition as a necessary condition for obtaining the output value in the case where the acquired condition is the input condition regarding the acquired condition as an output value at future time in the case where the acquired condition is an output condition, and detecting a leaf node having the regarded output value at the future time as a value of an object variable from the decision tree, acquiring a condition of explaining variables included in a rule associated with a path from the root node to the detected leaf node, as a condition for obtaining the regarded output value.

An inverse model calculation method for finding a condition under which a target system outputs a certain output value, the target system outputting the certain output value on the basis of an input value to the target system, the inverse model calculation method comprising: recording an input value inputted sequentially to the target system and an output value outputted sequentially from the target system as time series data; generating a decision tree for inferring an output value at future time, using the time series data, a path from a root node to a leaf node being associated in the decision tree with a rule including a condition of explaining variables and a value of an object variable; detecting a rule having an output value at future time as a value of an object variable, from the decision tree; in the case where a condition of explaining variables for a partial time zone in the detected rule matches the time series data, calculating a condition for obtaining the output value at the future time, using the detected rule and the time series data; in the case of non-matching, newly detecting a rule matching the condition of explaining variables for a partial time zone in the detected rule, from the decision tree; in the case where a condition of explaining variables for a partial time zone in the newly detected-rule does not match the time series data, further detecting a rule which the condition of explaining variables for a partial time zone in the newly detected rule matches, from the decision tree; repeating detecting a rule which a condition of explaining variables for a partial time zone in a latest detected rule matches, from the decision tree, until a rule whose condition of explaining variables for a partial time zone matches the time series data is detected; and calculating a condition required to obtain the output value at the future time by using all rules detected from the decision tree and the time series data, in the case where the rule whose condition of explaining variables for a partial time zone matches the time series data has been detected.

### BRIEF DESCRIPTION OF THE DRAWINGS

FIG. 1 is a block diagram showing a configuration of an inverse model calculation apparatus according to a first embodiment of the present invention.

FIG. 2 shows an input sequence of a variable X input to a target system and an output sequence of a variable Y output from the target system.

FIG. 3 is a diagram showing time series data including input sequence of variables X1 and X2 input to the target system and an output sequence of a variable Y output from the target system, in a table form.

FIG. 4 is a diagram showing a decision tree generated on the basis of the time series data shown in FIG. 3.

FIG. 5 is a diagram showing time series data including input sequence of variables X1 and X2 and an output sequence of a variable Y in a table form.

FIG. 6 is a table showing a data obtained by regarding the variable Y as an object variable and the variables X1 and X2 as explaining variables and rearranging the time series data shown in FIG. 5.

FIG. 7 is a flow chart showing processing steps performed by the inverse model calculation apparatus.

FIG. 8 is a flow chart showing processing steps of the subroutine A.

FIG. 9 is a block diagram showing a configuration of an inverse model calculation apparatus according to the second embodiment.

FIG. 10 is a flow chart showing the processing steps performed by the inverse model calculation apparatus shown in FIG. 9.

FIG. 11 is a flow chart showing processing steps in the subroutine B.

FIG. 12 is a flow chart showing processing steps performed by the inverse model calculation apparatus according to the third embodiment of the present invention.

FIG. 13 is a table showing a part that follows the time series data shown in FIG. 3.

FIG. 14 is a diagram showing time series data to be analyzed.

FIG. 15 is a table showing a state in which the time series data shown in FIG. 14 have been rearranged.

FIG. 16 shows a decision tree constructed on the basis of the table shown in FIG. 15.

FIG. 17 is a diagram showing the rules (1) to (13) in a table form.

FIG. 18 is a diagram explaining the logical inference.

FIG. 19 is a diagram showing concretely how logical inference is performed by combining the rule (10) with the rule (4).

FIG. 20 is a flow chart showing processing steps performed by the inverse model calculation apparatus.

FIG. 21 is a flow chart showing processing steps in the subroutine C in detail.

FIG. 22 is a flow chart showing processing steps in the subroutine D.

FIG. 23 is a flow chart showing processing steps in the subroutine E.

FIG. 24 is a block diagram showing a configuration of an inverse model computer system using an inverse model calculation apparatus.

FIG. 25 is a configuration diagram of a decision tree combination apparatus, which combines a plurality of decision trees.

FIG. 26 shows another example of the decision tree combination apparatus,

FIG. 27 is a table showing an example of observed data.

FIG. 28 shows data used to generate one decision tree (a decision tree associated with the object variable Y1).

FIG. 29 is a diagram showing examples of the decision tree 1 and the decision tree 2.

FIG. 30 is a flow chart showing a processing procedure for performing the combination method 1.

FIG. 31 shows a example of a series of explaining variable values.

FIG. 32 shows one generated instance data.

FIG. 33 is a flow chart showing a processing procedure for performing a combination method 2.

FIG. 34 is a flow chart showing a processing procedure at the step S1011.

FIG. 35 is a diagram showing an example of a path set.

FIG. 36 is a diagram showing a state in which the path set shown in FIG. 35 have been concatenated.

FIG. 37 shows a path (composite path) obtained by eliminating the duplication from the concatenated path shown in FIG. 36.

FIG. 38 shows 16 generated composite paths.

FIG. 39 is a flow chart showing the processing procedure at the step S1012 in detail.

FIG. 40 shows the decision tree in the middle of generation.

FIG. 41 shows the decision tree in the middle of generation.

FIG. 42 shows the decision tree in the middle of generation.

FIG. 43 shows the decision tree in the middle of generation.

FIG.44 shows a decision tree obtained by combining the decision tree 1 with the decision tree 2.

FIG. 45 is a flow chart showing a processing procedure for performing a combination method 3.

FIG.46 shows the decision tree in the middle of generation.

FIG.47 shows the decision tree in the middle of generation.

FIG. 48 shows a decision tree obtained by combining the decision tree 1 with the decision tree 2.

FIG. 49 is a diagram showing an evaluation method of a leftmost path in the composite decision tree.

### DETAILED DESCRIPTION OF THE INVENTION

(First Embodiment)

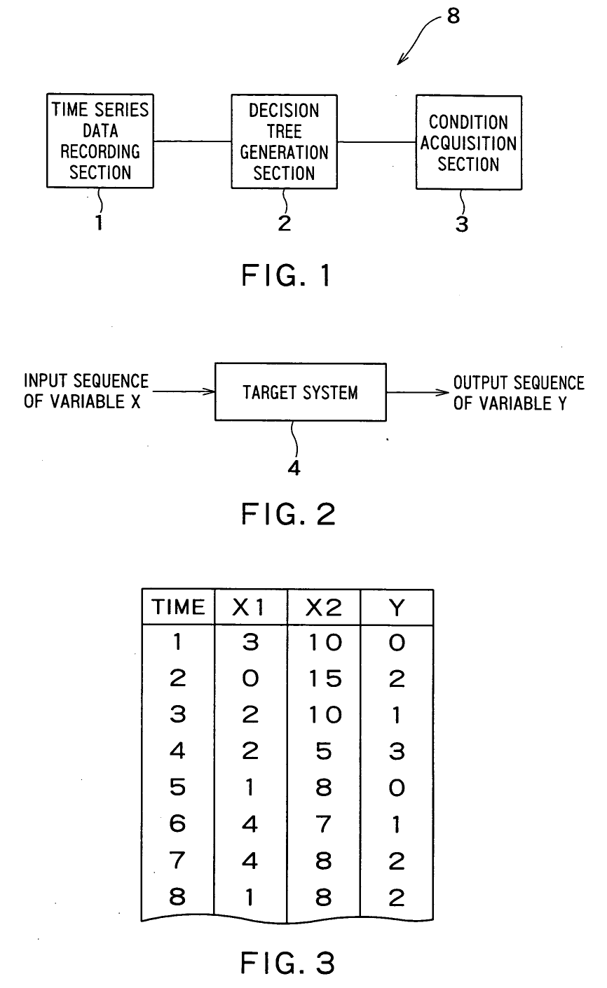

FIG. 1 is a block diagram showing a configuration of an inverse model calculation apparatus 8 according to a first embodiment of the present invention.

A time series data recording section 1 records input values inputted sequentially to a target system as an input sequence. A time series data recording section 1 records output values outputted sequentially from the target system as an output sequence. A time series data recording section 1 records the input sequence and the output sequence as time series data (observed data).

FIG. 2 shows an input sequence of a variable X input to a target system 4 and an output sequence of a variable Y output from the target system 4.

FIG. 3 is a diagram showing time series data including input sequence of variables X1 and X2 input to the target system 4 and an output sequence of a variable Y output from the target system 4, in a table form. As shown in the FIG. 3, in this target system 4, a one-dimensional output sequence is output on the basis of a two-dimensional input sequence.

A decision tree generation section 2 shown in FIG. 1 generates a decision tree for inferring an output sequence on the basis of an input sequence by using time series data stored in the time series data recording section 1.

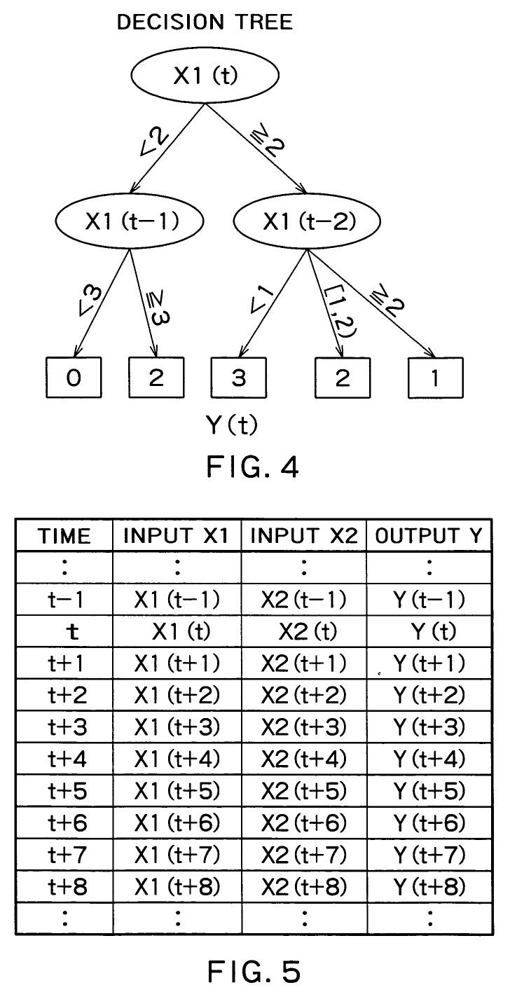

FIG. 4 is a diagram showing a decision tree generated on the basis of the time series data shown in FIG. 3.

In this decision tree, an output Y(t) at time t can be predicted on the basis of an input sequence of a variable X1 supplied until time t. Among the input sequence of the two variables X1 and X2, only the input sequence of the variable X1 appears in this decision tree, and the input sequence of the variable X2 does not appear. In other words, in this target system 4, the output Y can be predicted from only the input sequence of the variable X1. In this way, there is an effect of reducing the input variable used for the prediction by using a decision tree. The decision tree has a plurality of rules. Each rule corresponds to a path from a root node of the decision tree to a leaf node. In other words, the decision tree includes as many rules as the leaf nodes.

Here, as the specific generation method of the decision tree, an already known method can be used. Hereafter, the method required to generate the decision tree will be described briefly.

FIG. 5 is a diagram showing time series data including input sequence of variables X1 and X2 and an output sequence of a variable Y in a table form.

First, the already known method is applied to this time series data to rearrange this time series data.

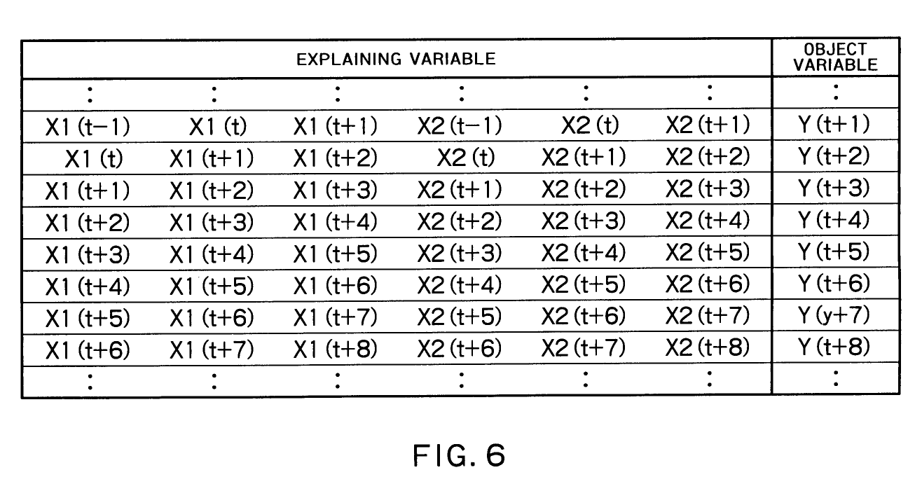

FIG. 6 is a table showing a data obtained by regarding the variable Y as an object variable and the variables X1 and X2 as explaining variables and rearranging the time series data shown in FIG. 5.

Subsequently, a method described in “C4.5: Programs for Machine Learning,” written by J. Ross Quinlan, and published by Morgan Kaufmann Publishers, Inc., 1993 is applied to the data shown in FIG. 6. As a result, a decision tree for predicting the output on the basis of the input sequence can be generated.

Returning back to FIG. 1, a condition acquisition section 3 acquires a condition required to obtain an output value at a given future time by tracing branches of the decision tree generated by the decision tree generation section 2 from a leaf node toward the root node. For example, if an output Y(10)=3 is given as an output at a future time in FIG. 4, then the condition acquisition section 3 specifies a leaf node corresponding to the output 3 in the decision tree, traces branches from the leaf node to the root node, and detects X1(10)>=2 and X1(8)<1. In other words, the condition acquisition section 3 specifies a rule having the output 3 as the leaf node, and acquires a condition included in this rule as a condition required to obtain the output 3.

Processing steps performed by the inverse model calculation apparatus 8 shown in FIG. 1 will now be described.

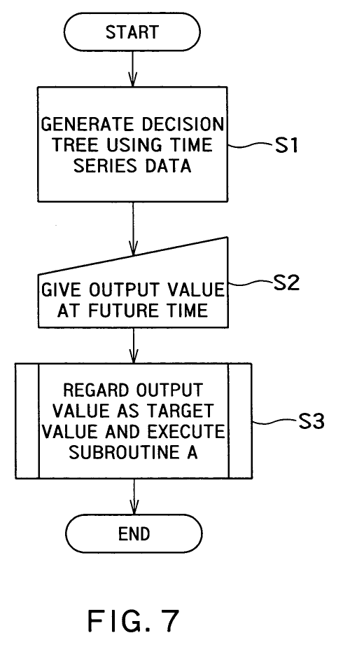

FIG. 7 is a flow chart showing processing steps performed by the inverse model calculation apparatus 8.

First, the decision tree generation section 2 generates a decision tree by means of time series data recorded by the time series data recording section 1 (step S1).

Subsequently, an output value (Y(t)=V) (output condition) at a future time is given to the condition acquisition section 3 by using data input means or the like, which is not illustrated (step S2).

The condition acquisition section 3 executes a subroutine A by regarding the output condition as a target condition (step S3).

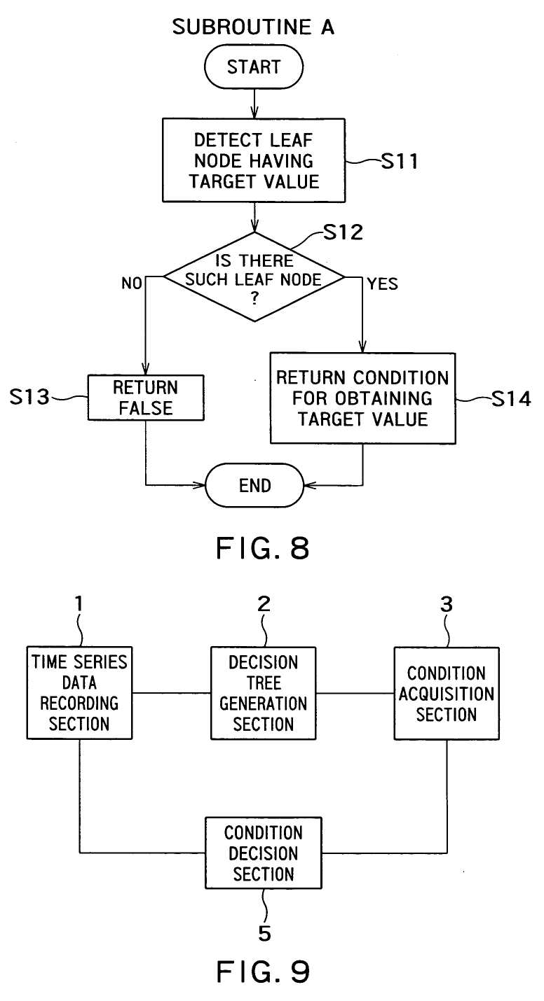

FIG. 8 is a flow chart showing processing steps of the subroutine A.

First, the condition acquisition section 3 retrieves a leaf node having a target value (=V) in the decision tree (step

If there is no leaf nodes having the target value (NO at step S12), then the condition acquisition section 3 outputs a signal indicating that the condition required to obtain the target value cannot be retrieved, i.e., the target value cannot be obtained (false) (step S13).

On the other hand, if there is a leaf node having the target value (YES at the step S12), then the condition acquisition section 3 traces the tree from the retrieved leaf node toward the root node, specifies a condition required to obtain the target value, and outputs the condition (step S14).

As a concrete example, it is now assumed that a condition required to obtain the target value 3 at time 100 is to be retrieved by using the decision tree shown in FIG. 4.

In the decision tree shown in FIG. 4, retrieval of a leaf node having a target value=3 is performed. As a result, a leaf node having the target value=3 is retrieved (Y(t)=3) (the step S1 and YES at the step S12). Assuming that t=100, a condition that X1(98)<1 and X1(100)>=2 is obtained by tracing the tree from the leaf node to the root node (X1(t)) (step S14).

An example of an inverse model computer system using the inverse model calculation apparatus 8 shown in FIG. 1 will now be described below.

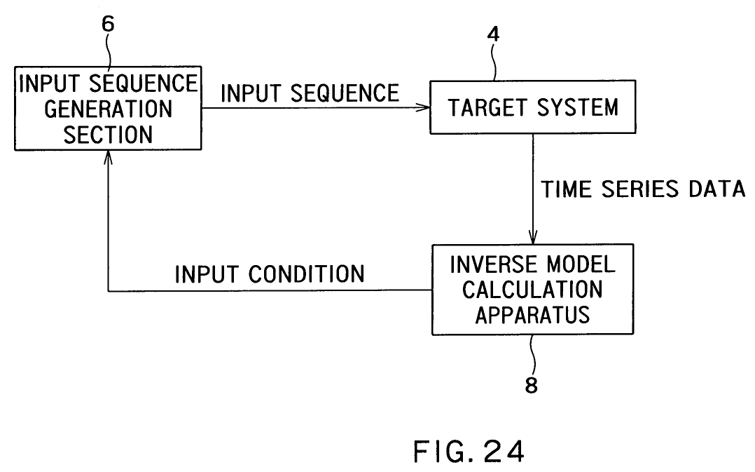

FIG. 24 is a block diagram showing a configuration of an inverse model computer system using an inverse model calculation apparatus 8.

An input sequence generation section 6 generates an input sequence of a variable X to be given to a target system 4. The target system 4 generates an output sequence of a variable Y on the basis of the input sequence of the variable X. An inverse model calculation apparatus 8 acquires the input sequence and the output sequence from the target system 4. The inverse model calculation apparatus 8 implements the above-described processing, calculates an input condition required to obtain an output value at a given future time, and outputs the calculated input condition to the input sequence generation section 6. The input sequence generation section 6 generates an input sequence in accordance with the input condition input thereto.

Heretofore, the inverse model calculation system incorporating the inverse model calculation apparatus 8 shown in FIG. 1 has been described. In the same way as the present embodiment, inverse model calculation apparatuses of the second to fifth embodiments described hereafter can also be incorporated in the inverse model computer system shown in FIG. 24.

According to the present embodiment, a decision tree is constructed as a model, and an input condition required to obtain an output value at a given future time is calculated, as heretofore described. Therefore, the amount of calculation can be reduced, and calculation of a value of an input variable that does not exert influence upon the output can be excluded.

According to the present embodiment, a decision tree is constructed as a model. Even if nonlinearity of the target system is strong, therefore, the precision of the model can be remained high.

(Second Embodiment)

The first embodiment shows a typical example of the inverse calculation using a decision tree, and it is indistinct whether the obtained condition can be actually satisfied. In the present embodiment, inverse calculation including a decision whether the obtained condition can be actually satisfied will now be described.

FIG. 9 is a block diagram showing a configuration of an inverse model calculation apparatus according to the second embodiment.

Since the time series data recording section 1, the decision tree generation section 2, and the condition acquisition section 3 are the same as those of the first embodiment, detailed description thereof will be omitted.

If an output condition is included in conditions obtained by the condition acquisition section 3, then a condition decision section 5 performs retrieval again by using the condition acquisition section 3 and using the output condition as the target condition. The condition decision section 5 repeats this processing until all conditions required to obtain a given output value are acquired as the input condition.

Hereafter, processing steps performed by the inverse model calculation apparatus shown in FIG. 9 will be described in detail.

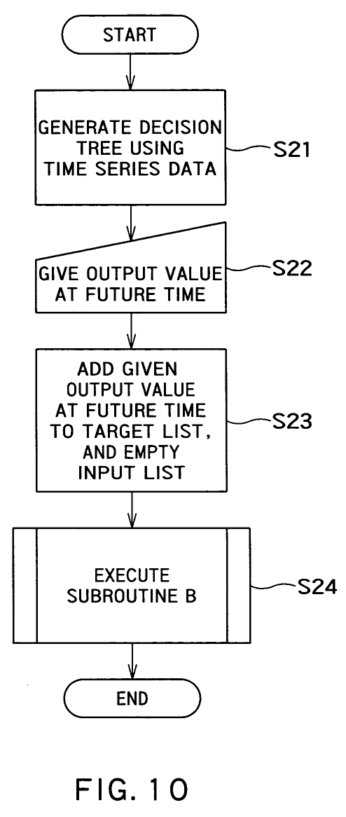

FIG. 10 is a flow chart showing the processing steps performed by the inverse model calculation apparatus shown in FIG. 9.

First, the decision tree generation section 2 generates a decision tree by using time series data recorded by the time series data recording section 1 (step S21).

Subsequently, the decision tree generation section 2 gives an output value at a future time (a target condition) to the condition decision section 5 by using data input means, which is not illustrated (step S22).

Subsequently, the condition decision section 5 generates a target list, which stores the target condition (step S23). The target list has a form such as “Y(100)=3, Y(101)=1, Y(102)=2, . . . ” (output 3 at time 100, output 1 at time 101 and output 2 at time 102). On the other hand, the condition decision section 5 especially prepares an input list, which stores obtained input conditions, and empties the input list (step S23).

In this state, the condition decision section 5 executes a subroutine B (step S24).

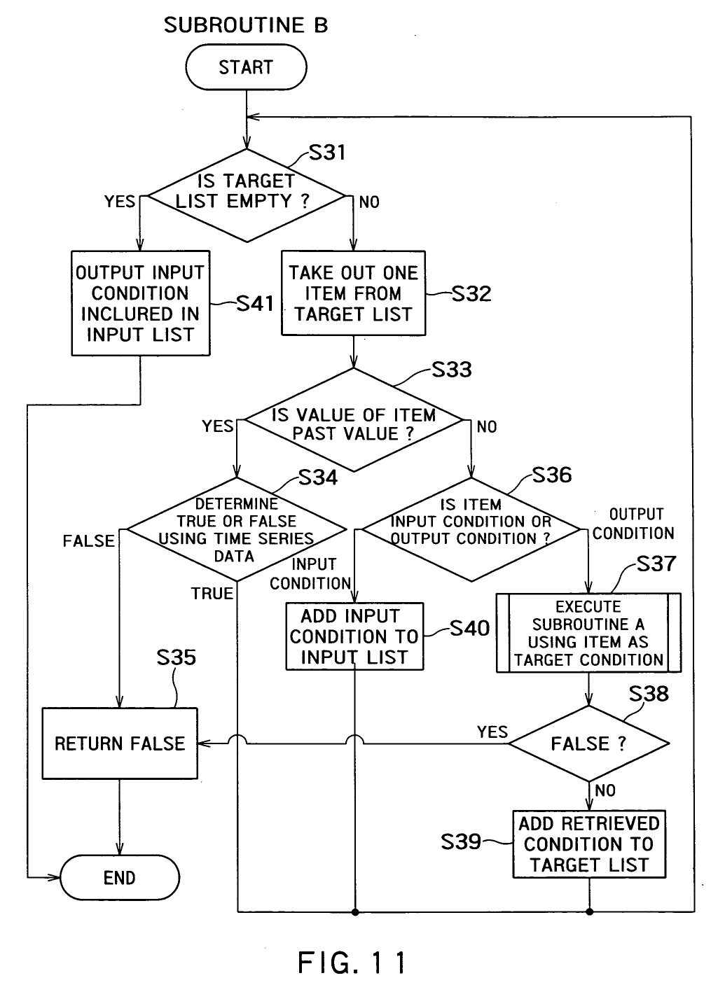

FIG. 11 is a flow chart showing processing steps in the subroutine B.

First, the condition decision section 5 determines whether the target list is empty (step S31).

If the target list is not empty (NO at the step S31), then the condition decision section 5 takes out one of items from the target list (step S32). For example, the condition decision section 5 takes out the target condition “Y(100)=3” from the above-described target list “Y(100)=3, Y(101)=1, Y(102)=2, . . . .” In this case, items in the target list is decreased by one, resulting in “Y(101)=1, Y(102)=2, . . . .”

The condition decision section 5 determines whether the item taken out is a past condition (step S33). If the current time is provisionally 10, then a target condition “Y(1)=2” is a past condition.

If the item taken out is a past condition (YES at the step 33), then the condition decision section 5 determines by using past time series data whether the item taken out is true or false (step S34). In other words, the condition decision section 5 determines whether the item taken out satisfies past time series data.

If the decision result is false, i.e., the item taken out does not satisfy past time series data (false at the step S34), then the condition decision section 5 outputs a signal (false) indicating that the given output value cannot be obtained (step S35).

On the other hand, if the decision result is true, i.e., the item taken out satisfies past time series data (true at the step S34), then the condition decision section 5 returns to the step S31.

If it is found at the step S33 that the item taken out is not a past condition, i.e., the item taken out is a future condition (NO at the step S33), then the condition decision section 5 determines whether the item is an input condition or an output condition (step S36).

If the item taken out is an output condition (output condition at the step S36), then the condition decision section 5 causes the condition acquisition section 3 to execute the subroutine A shown in FIG. 8 by using the output condition as the target condition (step S37). In other words, the condition decision section 5 requests the condition acquisition section 3 to retrieve a condition required to achieve that target condition. For example, if the item “Y(100)=3” taken out from the above-described target list is a future condition, then the condition decision section 5 causes the condition acquisition section 3 to execute the subroutine A by using “Y(100)=3” as the target condition. The condition decision section 5 receives a retrieval result from the condition acquisition section 3.

If the retrieval result received from the condition acquisition section 3 is false (YES at the step S38), i.e., if a leaf node having the target value under the target condition is not present in the decision tree, then the condition decision section 5 outputs a signal indicating that an output value at a given future time cannot be obtained (false) (step S35).

On the other hand, if the retrieval result received from the condition acquisition section 3 is not false (NO at the step S38), i.e., if a condition (an input condition, an output condition, or an input condition and an output condition) required to achieve the target condition is received from the condition acquisition section 3 as the retrieval result, then the condition decision section 5 adds this condition to the target list as a target condition (step S39).

If the item taken out is an input condition at the step S36 (input condition at the step S36), then the condition decision section 5 adds this input condition to the input list (step S40). The input list has a form such as “X1(100)=2, X1(101)=3, X2(100)=1 . . . .”

Thereafter, the condition decision section 5 returns to the step S31, and repeats the processing heretofore described. If the target list has become empty (YES at the step S31), then the condition decision section 5 outputs an input condition stored in the input list, as a necessary condition required to obtain an output value at a given future time (outputs true) (step S41).

The present embodiment has been described heretofore. If the detected condition is a past condition, then truth or false is determined by comparing this condition with past time series data. If the detected condition is a future output condition, then retrieval is performed repeatedly. Therefore, it can be determined whether an output value at a given future time will be possible, if possible, a condition required to obtain the output value can be acquired as an input condition.

(Third Embodiment)

In the present embodiment, how many time units after the current time an output value at a given future time can be acquired at the shortest will now be described.

A configuration of an inverse model calculation apparatus in the present embodiment is basically the same as that in the second embodiment shown in FIG. 9. However, the present embodiment differs from the second embodiment in processing performed by the condition decision section 5.

Hereafter, the inverse model calculation apparatus in the present embodiment will be described.

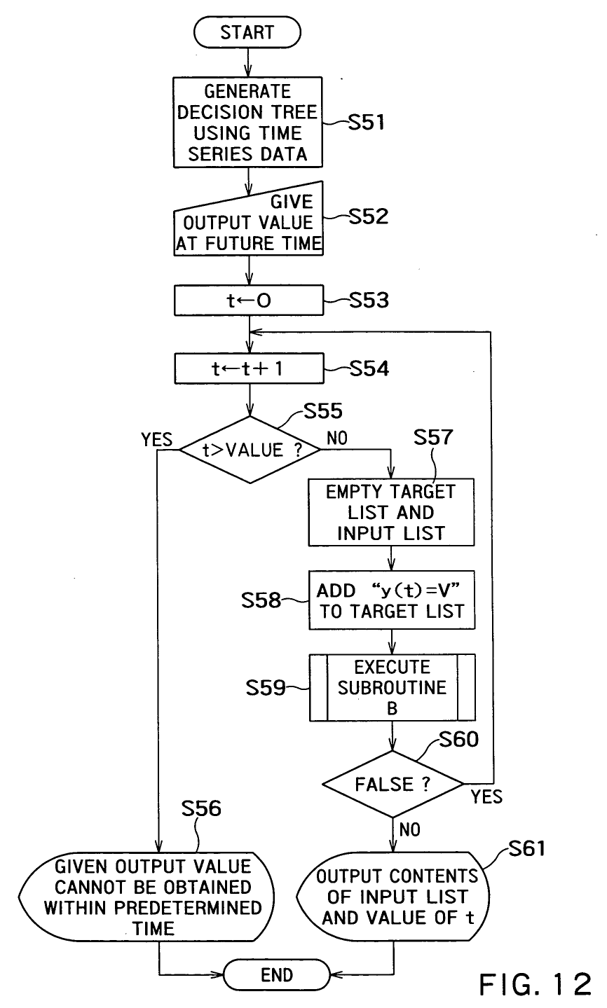

FIG. 12 is a flow chart showing processing steps performed by the inverse model calculation apparatus according to the third embodiment of the present invention.

First, the decision tree generation section 2 generates a decision tree by using time series data recorded by the time series data recording section 1 (step S51).

Subsequently, the decision tree generation section 2 gives an output value at a future time (supplies a target condition) to the condition decision section 5 by using data input means, which is not illustrated (step S52).

Subsequently, the condition decision section 5 substitutes an initial value 0 for time t (step S53). As for the initial value, the last time when an output value is present in the above-described time series data is substituted. (For example, if there are input values and output values at time 1 to time 8 and only an input value at time 9 in the time series data, then the last time becomes 8.) Here, 0 is substituted as the initial value for brevity of description.

Subsequently, the condition decision section 5 substitutes t+1 for time t. In other words, the condition decision section 5 increases the time t by one (step S54). This “1” is, for example, an input spacing time of the input sequence inputted to the target system.

Subsequently, the condition decision section 5 determines whether the time t is greater than a predetermined value (step S55).

If the time t is greater than the predetermined value (YES at the step S55), then the condition decision section 5 outputs a signal indicating that the given output value V cannot be obtained within the predetermined time (step S56).

On the other hand, if the time t is equal to the predetermined value or less (NO at the step S55), then the condition decision section 5 empties the target list and the input list (step S57), and adds a target condition “Y(t)=V” (output V at time t) to the target list.

Upon adding the target condition “Y(t)=V” to the target list, the condition decision section 5 executes the above-described subroutine B (see FIG. 11) (step S59).

If a result of the execution of the subroutine B is false (YES at step S60), i.e., an input condition required to achieve Y(t)=V cannot be obtained, then the condition decision section 5 further increases the time t by one (step S54) and repeats the above-described processing (steps S55 to S59).

On the other hand, if the result of the execution of the subroutine B is not false (NO at the step S60), i.e., an input condition required to achieve Y(t)=V can be obtained, then the condition decision section 5 outputs the input condition and the value of the time t (step S61).

Processing steps performed by the inverse model calculation apparatus heretofore described will be further described by using a concrete example.

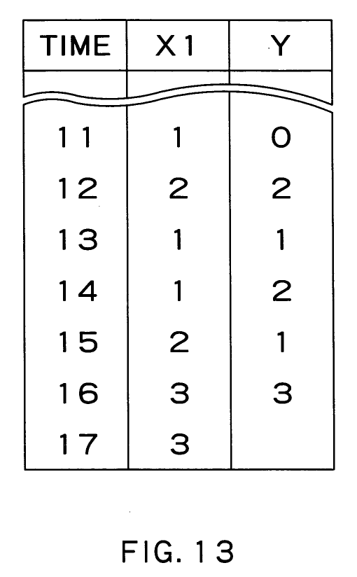

FIG. 13 is a table showing a part that follows the time series data shown in FIG. 3. However, the variable X2 is omitted.

An input value of the variable X1 and an output value of the variable Y until time 16, and an input value of the variable X1 at time 17 are already obtained.

An example in which the inverse model calculation apparatus calculates what time the output value subsequently becomes 3 (Y(t)=3) will now be described.

First, the decision tree generation section 2 generates a decision tree by using time series data shown in FIGS. 3 and 13 (the same tree as that shown in FIG. 4 is generated) (the step 51 in FIG. 12). Subsequently, a target condition (Y(t)=3) is input to the condition decision section 5 via input means, which is not illustrated (step S52).

The condition decision section 5 substitutes 16 for time t (step S53). In other words, the condition decision section 5 substitutes the last time when an output value exists for t.

The condition decision section 5 increases the time t by one to obtain 17 (step S54).

The condition decision section 5 determines whether the time (=17) is greater than a predetermined value (step S55). Here, the condition decision section 5 determines t (=17) to be equal to the predetermined value or less (NO at the step S55), and empties the target list and the input list (step S57).

The condition decision section 5 adds a target condition “Y(17)=3” to the target list (step S58), and executes the subroutine B (step S59). The condition decision section 5 determines the execution result to be false (YES at step S60).

In other words, to achieve Y(17)=3 when t=18, it is necessary to satisfy X1(15)<1 and X1(17)>=2 as represented by the decision tree shown in FIG. 4 (the steps S31, S32, S33, S36, S37, NO at S38, and S39 in the subroutine B). As shown in FIG. 13, however, X1 is 2 at time 15, and consequently the above-described X1(15)<1 is not satisfied (steps S31, S32, S33 and false at step S34 following the step S39). At the time 17, therefore, the condition decision section 5 determines that the output value Y=3 cannot be obtained (step S35 following the step S34).

As a result, the condition decision section 5 returns to the step S54 as shown in FIG. 12, and increases t by one to obtain 18. And the condition decision section 5 executes the subroutine B again, via the steps S57 and 58 (step S59). Here as well, the condition decision section 5 determines the execution result to be false (YES at step S60).

In other words, to achieve Y(18)=3 when t=18, it is necessary to satisfy X1(16)<1 and X1(18)>=2 as represented by the decision tree shown in FIG. 4 (the steps S31, S32, S33, S36, S37, NO at S38, and S39 in the subroutine B). As shown in FIG. 13, however, X1 is 3 at the time 16, and consequently X1(16)<1 is not satisfied (steps S31, S32, S33 and false at step S34 following the step S39). At the time 18, therefore, the condition decision section 5 determines that the output value Y=3 cannot be obtained (step S35 following the step S34).

As a result, the condition decision section 5 returns to the step S54 as shown in FIG. 12, and increases t by one to obtain 19. And the condition decision section 5 executes the subroutine B again, via the steps S57 and 58 (step S59). Here as well, the condition decision section 5 determines that the execution result is false (YES at step S60).

In other words, to achieve Y(19)=3 when t=19, it is necessary to satisfy X1(17)<1 and X1(19)>=2 as represented by the decision tree shown in FIG. 4 (the steps S31, S32, S33, S36, S37, NO at S38, and S39 in FIG. 11). As shown in FIG. 13, however, X1 is 3 at the time 17, and consequently X1(17)<1 is not satisfied (steps S31, S32, S33 and false at step S34 following the step S39). At the time 19, therefore, the condition decision section 5 determines that the output value Y=3 cannot be obtained (step S35 following the step S34).

As a result, the condition decision section 5 returns to the step S54 as shown in FIG. 12, and increases t by one to obtain 20. And the condition decision section 5 executes the subroutine B again, via the steps S57 and 58 (step S59). The condition decision section 5 determines that the execution result is not false (NO at step S60).

In other words, to achieve Y(20)=3 when t=20, it is necessary to satisfy X1(18)<1 and X1(20)>=2 as represented by the decision tree shown in FIG. 4 (the steps S31, S32, S33, 536, S37, NO at S38, and 539 in FIG. 11). Both of these two input conditions are future conditions (steps 531, 532, NO at step S33 following 539). Therefore, the condition decision section 5 adds these two input conditions to the input list (input condition at step S36 and 540 following the step 533). The condition decision section 5 outputs an input condition in the input list and the value 20 of time t (YES at step S31, S41 following the step 540, and NO at the step S60 and S61 in FIG.12).

According to the present embodiment, an input condition required to obtain a given output value is retrieved while successively increasing the value of a future time t as heretofore described. Therefore, it is possible to calculate how many time units after the current time an output value at a given future time can be acquired at the shortest.

(Fourth Embodiment)

In the present embodiment, an input condition required to obtain an output value at a given future time is calculated by performing “logical inference” using a plurality of rules (paths from the root node to leaf nodes) included in the decision tree and using time series data.

The present embodiment differs from the second and third embodiments in processing contents performed by the condition acquisition section 3 and the condition decision section 5.

Hereafter, the present embodiment will be described in detail.

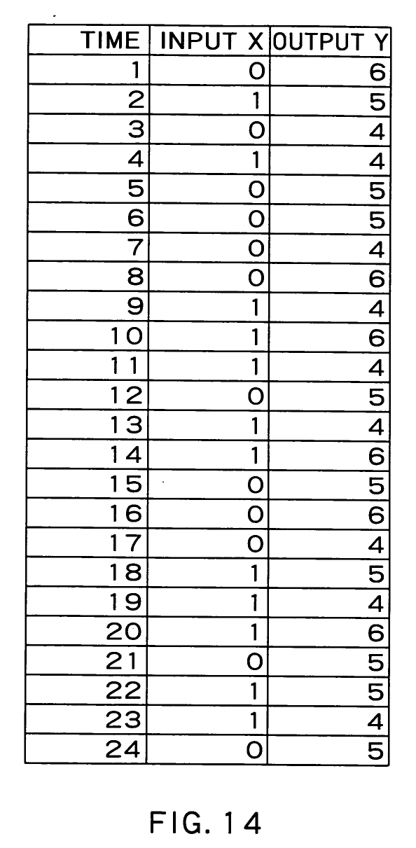

FIG. 14 is a diagram showing time series data to be analyzed.

The time series data are rearranged by regarding Y at time t as an object variable and regarding X at the time (t-2) to t and Y at time t-1, t-2 as explaining variables.

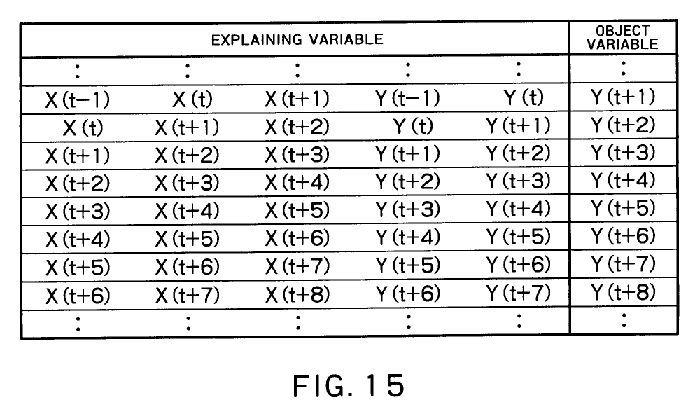

FIG. 15 is a table showing a state in which the time series data shown in FIG. 14 have been rearranged.

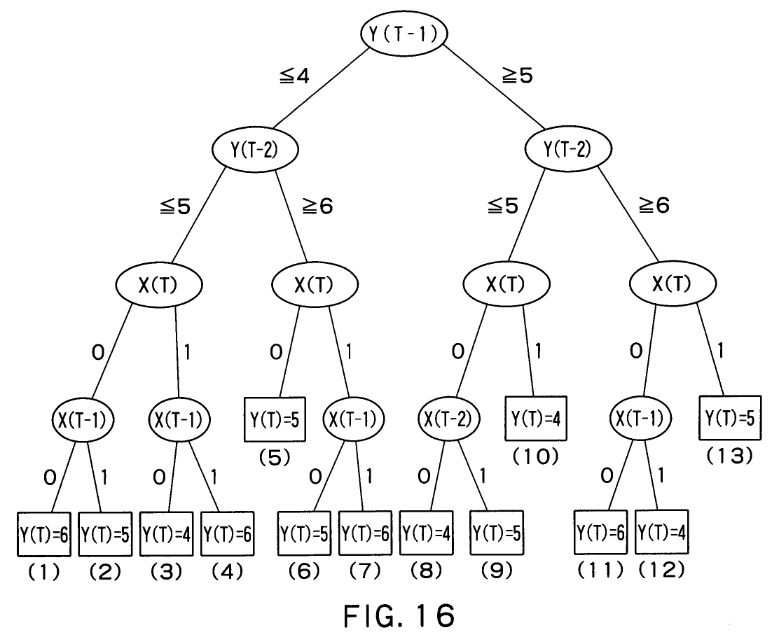

A decision tree is constructed by applying an already known method to this table. FIG. 16 shows a decision tree constructed on the basis of the table shown in FIG. 15. This decision tree is generated by the decision tree generation section 2.

The condition acquisition section 3 traces branches of this decision tree from the root node to a leaf node, and acquires the following 13 rules (paths).

(1) Y(T−1)<=4, Y(T−2)<=5, X(T)=0, X(T−1)=0→Y(T)=6

(2) Y(T−1)<=4, Y(T−2)<=5, X(T)=0, X(T−1)=1→Y(T)=5

(3) Y(T−1)<=4, Y(T−2)<=5, X(T)=1, X(T−1)=0→Y(T)=4

(4) Y(T−1)<=4, Y(T−2)<=5, X(T)=1, X(T−1)=1→Y(T)=6

(5) Y(T−1)<=4, Y(T−2)=>6, X(T)=0,→Y(T)=5

(6) Y(T−1)<=4, Y(T−2)=>6, X(T)=1, X(T−1)=0→Y(T)=5

(7) Y(T−1)<=4, Y(T−2)=>6, X(T)=1, X(T−1)=1→Y(T)=6

(8) Y(T−1)=>5, Y(T−2)<=5, X(T)=0, X(T−2)=0→Y(T)=4

(9) Y(T−1)=>5, Y(T−2)<=5, X(T)=0, X(T−2)=1→Y(T)=5

(10) Y(T−1)=>5, Y(T−2)<=5, X(T)=1,→Y(T)=4

(11) Y(T−1)=>5, Y(T−2)=>6, X(T)=0, X(T−1)=0→Y(T)=6

(12) Y(T−1)=>5, Y(T−2)=>6, X(T)=0, X(T−1)=1→Y(T)=4

(13) Y(T−1)=>5, Y(T−2)=>6, X(T)=1,→Y(T)=5

In these rules, “A, B, C→D” means that if A, B and C hold, then D holds.

For example, the rule of (1) means that if the output before one time unit is 4 or less, the output before two time units is 5 or less, the current input is 0 and the input before one time unit is 0, then it is anticipated that the current output will become 6.

It is now assumed to be requested to determine when what input should be given (input condition) in order to obtain Y=6 at a time later than the time 24 in the time series data shown in FIG. 14.

In the present embodiment, “logical inference” is performed by using the time series data shown in FIG. 14 and the rules (1) to (13) in order to determine this input condition. This logical inference is performed by the condition decision section 5. Hereafter, this logical inference will be described.

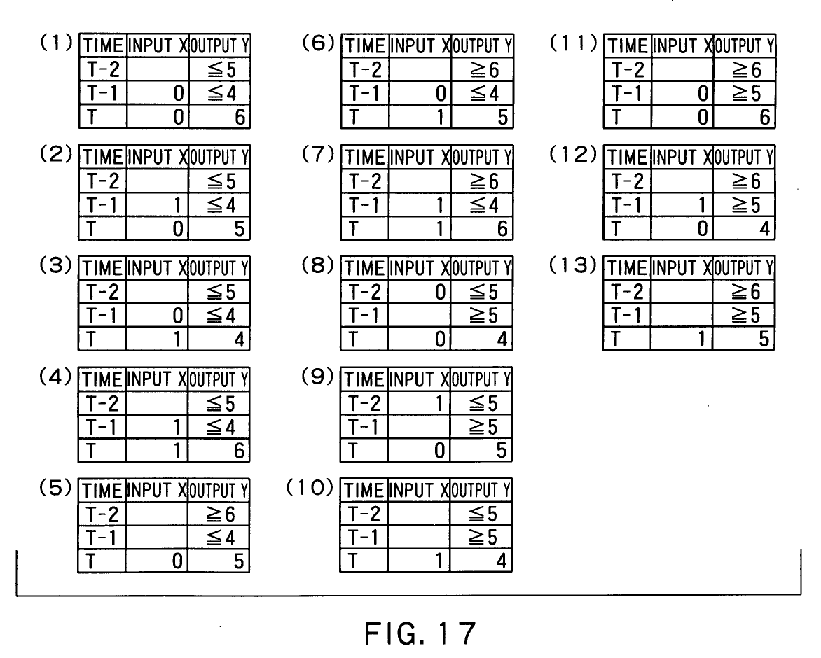

FIG. 17 is a diagram showing the rules (1) to (13) in a table form.

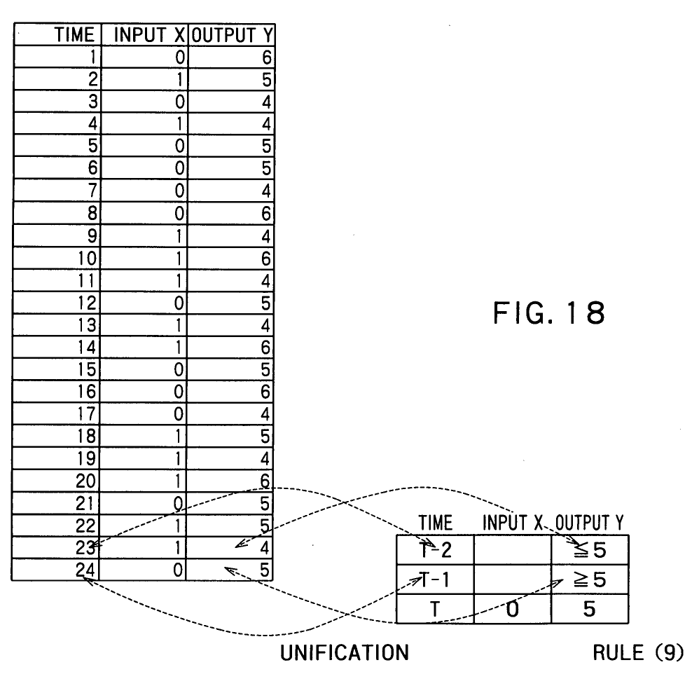

FIG. 18 is a diagram explaining the logical inference.

The logical inference predicts how the time series data changes after the next time while superposing at least the bottom end (last time) of the time series data on the rules as shown in FIG. 18.

In the example shown in FIG. 18, logical inference is performed by using the time series data shown in FIG. 14 and the rule (9). In more detail, the value of Y in the time series data at time 23 is 4, and the output at time T−2 in the rule (9) is “5 or less,” and consequently they match each other. Furthermore, the value of X in the time series data at time 23 is 1, and the input at time T−2 in the rule (9) is 1, and consequently they match each other. In addition, the value of Y in the time series data at time 24 is 5, and the output at time T−1 in the rule (9) is “5 or more,” and consequently they also match each other. If 0 is given as X at time 25 (=T), therefore, it is anticipated that Y will become 5.

In the case of this example, the matched time zone (unified time zone) is two time units. In other words, the unified time zone includes time 24 and 25 in the time series data, and time T−2 and T−1 in the rule. As a matter of course, however, the unified time zone differs according to the size of the time zone included in the rule. If the time zones in the rule are T−10 to T, then, for example, ten time zones T−10 to T−1 are used.

By using this logical inference, an input condition required to obtain Y=6 at a time later than the time 24 in FIG. 14 is determined.

First, rules in which Y(T) is 6 are selected from among the rules (1) to (13) shown in FIG. 17, resulting in the rules (1), (4), (7) and (11).

Subsequently, it is determined whether these rules (1), (4), (7) and (11) match the time series data shown in FIG. 14.

As for the rule (1), if time T−2 and T−1 in the rule (1) are respectively associated with time 23 and 24 in the time series data, then Y=5 at time 24 does not satisfy Y<=4 at time T−1. Therefore, the rule (1) does not match the time series data.

As for the rule (4), if time T−2 and T−1 in the rule (4) are respectively associated with time 23 and 24 in the time series data, then Y=5 at time 24 does not satisfy Y<=4 at time T−1. Therefore, the rule (4) does not match the time series data.

Determining for the rules (7) and (11) as well in the same way, neither of these rules matches the time series data.

Therefore, logical inference is performed by combining these rules.

In this case, rules are combined basically as a round robin. As a result, an input condition required to obtain Y=6 is determined by combining the rule (10) with the rule (4). A rule selection scheme to be used when combining rules is described in, for example, Journal of Information Processing Society of Japan, Vol. 25, No. 12, 1984.

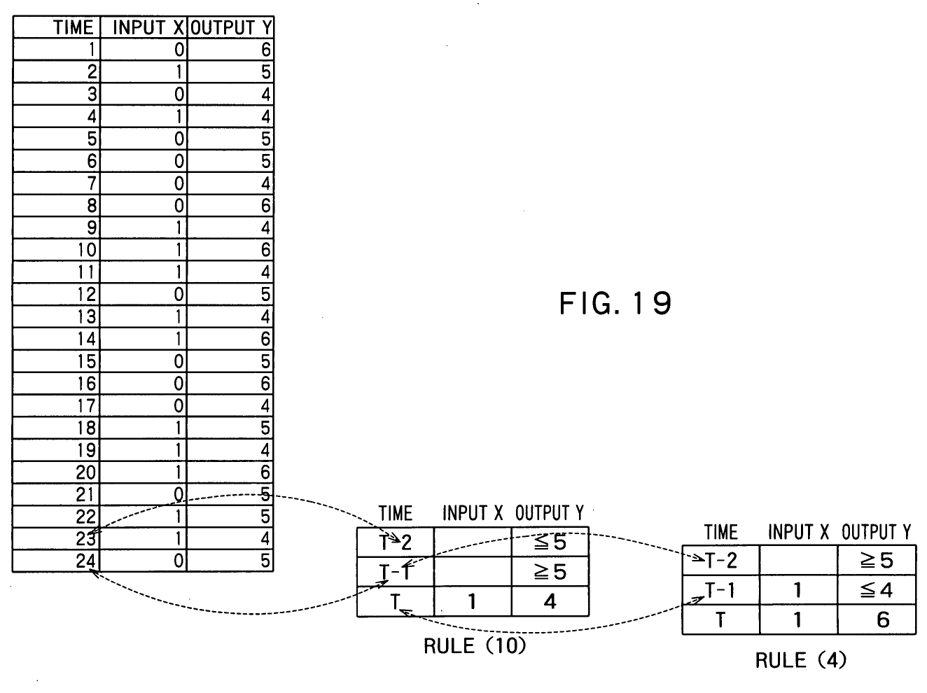

FIG. 19 is a diagram showing concretely how logical inference is performed by combining the rule (10) with the rule (4).

If time T−2 and time T−1 in the rule (4) are respectively associated with time T−1 and T in the rule (10) as shown in FIG. 19, then it will be appreciated that they match each other. Furthermore, if time T−2 and time T−1 in the rule (10) are respectively associated with time 23 and 24 in the time series data, then it will also be appreciated that they match each other.

If X=1 is given as the input at time 25, therefore, then it is anticipated that Y=4 will be outputted according to the rule (10). If X=1 is given as the input at time 26, then it is anticipated that Y=6 will be outputted according to the rule (4).

Processing steps performed by the inverse model calculation apparatus according to the present embodiment will now be described below.

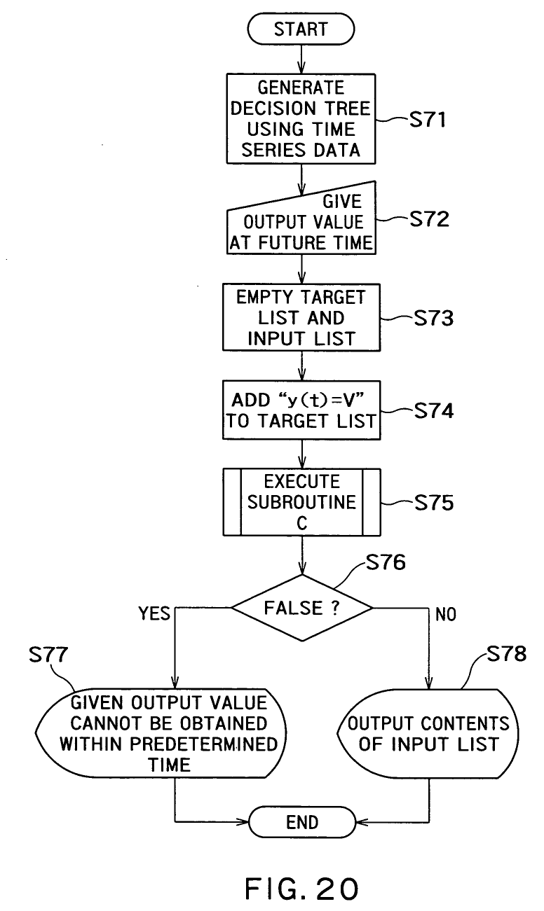

FIG. 20 is a flow chart showing processing steps performed by the inverse model calculation apparatus.

First, the decision tree generation section 2 generates a decision tree by using time series data recorded in the time series data recording section 1 (step S71).

Subsequently, the decision tree generation section 2 gives an output value V at a future time (an output condition) to the condition decision section 5 (step S72).

The condition decision section 5 empties the target list and the input list (step S73), and adds an output condition “y(t)=V” to the target list as a target condition (step S74).

The condition decision section 5 executes a subroutine C described later (step S75).

If a result of the execution of the subroutine C is false (YES at step S76), then the condition decision section 5 outputs a signal indicating that the given output value V cannot be obtained within a predetermined time (step S77).

On the other hand, if the execution result of the subroutine C is true (NO at the step S76), then the condition decision section 5 outputs contents of the input list (input condition and value of time t) obtained in the subroutine C (step S78).

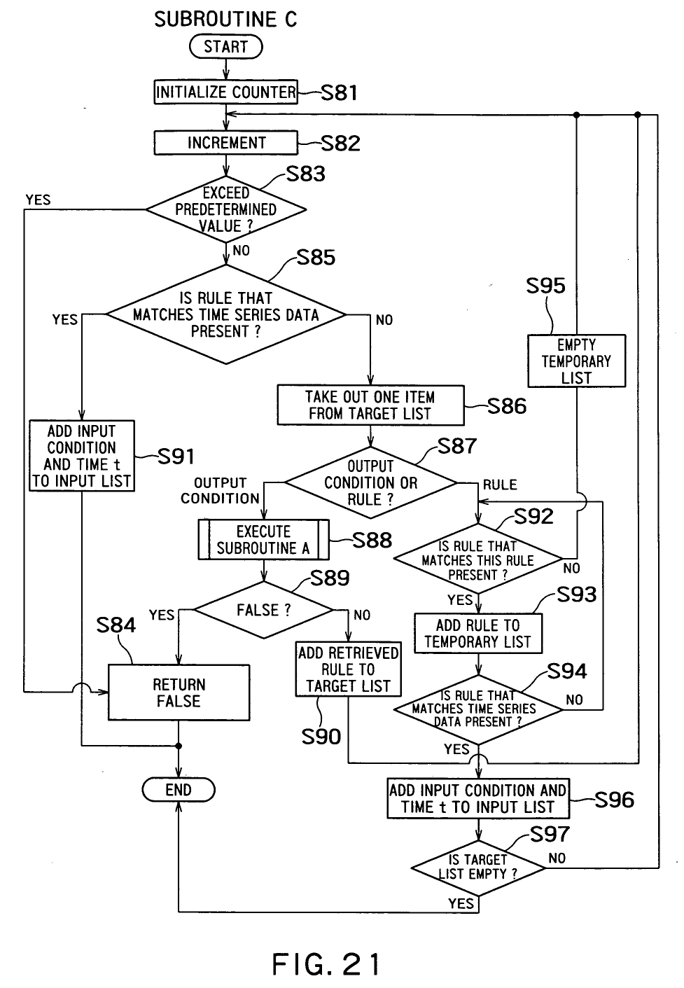

FIG. 21 is a flow chart showing processing steps in the subroutine C in detail.

First, the condition decision section 5 initializes a counter (for example, number of times i=0) (step S81), and increments the i (i=i+1) (step S82).

Subsequently, the condition decision section 5 determines whether the number of times i has exceeded a predetermined value (step S83).

If the i has exceeded the predetermined value (YES at the step S83), then the condition decision section 5 outputs a signal indicating that the given output value cannot be obtained (false) (step S84).

On the other hand, if the i has not exceeded the predetermined value (NO at the step S83), then the condition decision section 5 determines whether a rule matching the time series data is present in the target list (step S85).

At the current time, a rule is not stored in the target list. Therefore, the condition decision section 5 determines that such an item is not present (NO at the step S85), and takes out one item from the target list (step S86).

The condition decision section 5 determines whether the item taken out is an output condition or a rule (step S87).

If the condition decision section 5 determines the item taken out to be an output condition (this holds true at the current time) (output condition at the step S87), then the condition decision section 5 causes the condition acquisition section 3 to execute the subroutine A by using the item as the target condition, and receives a retrieval result (a rule including a value of the target condition in a leaf node) from the condition acquisition section 3 (step S88). For example, if the output value V is 5 in FIG. 16, then five rules (2), (5), (6), (9) and (13) are obtained by the subroutine A. If the output value V is 6, then four rules (1), (4), (7) and (11) are obtained.

If the retrieval result is false (YES at step S89), then the condition decision section 5 outputs a signal indicating that the given output value cannot be obtained (false) (step S84).

On the other hand, if the retrieval result is not false (NO at the step S89), then the condition decision section 5 adds the rules acquired by the condition acquisition section 3 to the target list (step S90).

Subsequently, the condition decision section 5 increments the i (step S82). If the condition decision section 5 determines that the i does not exceed a predetermined value (NO at the step S83), then the condition decision section 5 determines whether a rule that matches the time series data is present in the target list (step S85). If the output value V is 5 in FIG. 17, then the rules (9) and (13) included in the rules (2), (5), (6), (9) and (13) match the time series data as shown in FIG. 14. In this case, the condition decision section 5 determines that a matching rule is present (YES at the step 85). The condition decision section 5 specifies an input condition and time t on the basis of the matching rule and the time series data, and adds the input condition and the time t to the input list (step S91). Here, X(25)=0 (rule (9)), X(25)=1 (rule (13)), and time t=25 are added to the input list (step S91).

On the other hand, if a rule matching the time series data is not present at the step S85 (NO at the step S85), then one item is taken out from the target list (step S86). For example, the rules (1), (4), (7) and (11) in the case where the output value V is 6 in FIG. 17 do not match the time series data. Therefore, one of these items (rules) is taken out from the target list. Here, for example, the rule (4) is taken out (rule at the step S87).

The condition decision section 5 causes the condition acquisition section 3 to determine whether a rule that matches the rule taken out (object rule) is present (step S92).

If such a rule is present (YES at the step S92), then the condition decision section 5 adds that rule to a temporary list together with the above-described object rule (step S93). If the output value V is 6 in FIG. 17, then rules (10) and (13) are present as rules matching the rule (4). Therefore, the rule (4) serving as the object rule, and the rules (10) and (13) obtained as matching the rule (4) are stored in the temporary list.

The condition decision section 5 determines whether the obtained rules in the temporary list match the time series data (step S94). In the above described example, the condition decision section 5 determines whether the rule (10) or the rule (13) matches the time series data.

If a matching rule is present (YES at step S94), then the condition decision section 5 specifies the input condition and the time t on the basis of the matching rule and the object rule, and adds the input condition and the time t to the input list (step S96). For example, in the above-described example, the condition decision section 5 specifies X(25)=1 as the input condition on the basis of the rule (10) and X(26)=1 as the input condition on the basis of the rule (4), and adds these input conditions to the input list together with time t=26.

The condition decision section 5 determines whether the target list is empty (step S97). If the target list is empty (YES at the step S97), then the condition decision section 5 terminates the subroutine C. If the target list is not empty (NO at the step S97), then the condition decision section 5 empties the temporary list, and returns to the step S82.

If the obtained rule in the temporary list does not match the time series data at the step S94 (NO at the step S94), then the condition decision section 5 performs the steps S92 and S93 again by using the rule that does not match as an object rule. If a rule that matches the object rule is obtained (YES at the step S92), then the condition decision section 5 adds the rule to the temporary list (step S93). On the other hand, if a rule is not obtained (NO at the step S92), then the condition decision section 5 empties the temporary list (step S95), and returns to the step S82.

According to the present embodiment, a condition required to obtain a given output value is calculated by combining rules obtained from the decision tree so as to go back in time. Therefore, condition calculation can be terminated in a short time.

(Fifth Embodiment)

In the fourth embodiment, the whole time zone except the current time T is used as the time zone of matching between rules and matching between a rule and time series data, i.e., the time zone of unification. In the fourth embodiment, the time zone of the unification is two time units ranging from T−2 to T−1. If rules are unified in the whole time zone except the current time in the case where the time zone included in the rules is long, then a high-precision inference is anticipated, but a large amount of calculation is requested, resulting in inefficiency in many cases. If unification can be performed in a shorter time zone, then the efficiency is high. If the time zone of unification is made shorter, however, a problem to which inference precision fall may occur. In the present embodiment, therefore, a value effective as a time zone of unification is calculated and unification is performed with that value, and thereby inference is implemented with a small amount of calculation and with high precision.

First, the relation between the time zone of unification and the inference precision will be described briefly.

The relation will now be described by taking the rule (4) as an example. As described above, “Y(T−1)<4, Y(T−2)<=5, X(T)=1, X(T−1)=1→Y(T)=6” in the rule (4) means that the result on the right side (the value of the object variable) is obtained when all conditions (conditions of the explaining variables) on the left side in this logical expression hold. If X(T−1)=1 is set after Y(T−2)<=5 has held, then it is indistinct from the rule (4) whether Y(T−1)<=4. In other words, it is indistinct whether the value of Y at each time in the rule holds if a condition before that time and at that time has held.

In the present embodiment, a probability (stochastic quantity) that an output condition at each time included in the rule will hold in the case where conditions before that time and at that time hold is found, and unification is performed in a minimum time zone having the probability higher than a threshold. As a result, it can be anticipated to perform logical inference with a minimum calculation quantity and high precision. Hereafter, this will be described in more detail by taking the rule (4) as an example.

Hereafter, the probability that an output condition at each time included in the rule (4) will hold in the case where conditions before that time and at that time hold will be described by using the time series data shown in FIG. 14.

First, as for Y(T−2)<=5 in the rule (4), other conditions before this time and at this time are not present, and consequently it will be omitted.

Subsequently, as for Y(T−1)<=4, it is checked whether it holds assuming that X(T−1)=1 when Y(T−2)<=5 holds. As a result, it holds at time 4, 13, 19 and 23, and it does not hold at time 10, 14, 18, 20 and 22 in the time series data in FIG. 14. Therefore, the probability that Y(T−1)<=4 will hold is 44% (=4/9×100%).

Therefore, as for the rule (4), if the threshold is set equal to 40%, it can be the that unification using two time zones (T−2, T−1) is suitable.

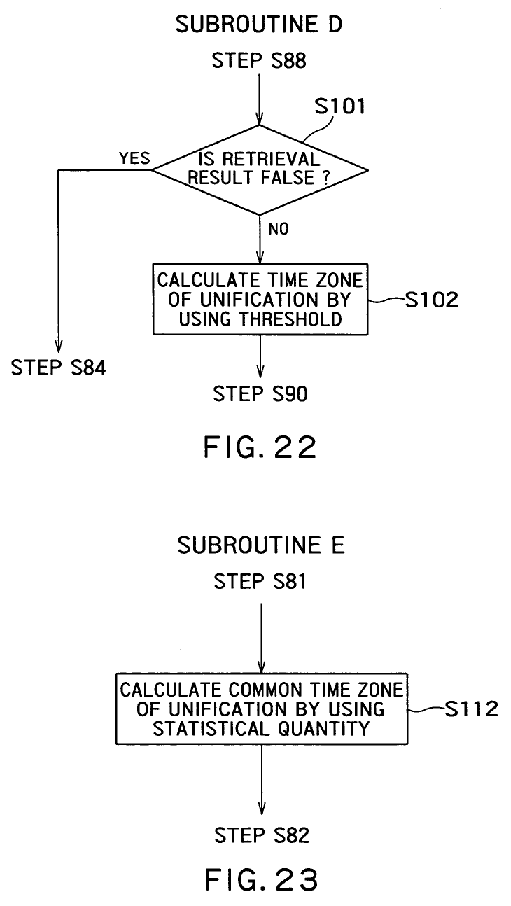

Processing steps of calculating time zones in which unification is performed and performing the unification in the calculated time zones will now be described. This is achieved by executing a subroutine D shown in FIG. 22 instead of the step S89 shown in FIG. 21.

FIG. 22 is a flow chart showing processing steps in the subroutine D.

If a result of retrieval performed by the condition acquisition section 3 is not false (NO at step 101), then the condition decision section 5 calculates the probability that an output condition at each time in each of the rules acquired from the condition acquisition section 3 will hold when a condition at an earlier time and at the time holds, on the basis of the time series data in the time series data recording section 1 (step S102). The condition decision section 5 sets a minimum time zone having the probability greater than a threshold as the time zone for unification (step S102). The condition decision section 5 adds each retrieved rule to the target list together with the time zone of unification of each rule (step S90). In the steps S85, S92 and S94 of performing unification (see FIG. 21), the condition decision section 5 performs unification by using the calculated time zone. If a new rule is acquired at the step S92, then the condition decision section 5 finds a time zone in the same way.

On the other hand, if the result of the retrieval performed by the condition acquisition section 3 is false (YES at the step S101), then the condition decision section 3 proceeds to the step S84, and outputs a signal (false) indicating that the given output value V cannot be obtained.

At the above-described step S102, the time zone of unification has been calculated for each of rules. However, a time zone common to all rules may be found. Specifically, the condition decision section 3 calculates an average of holding probability of the output condition at each time for all rules, and uses a time zone having the average exceeding the threshold as a time zone common to the rules.

This is implemented by adding a subroutine E shown in FIG. 23 between, for example, steps S81 and S82 shown in FIG. 21.

In other words, the condition decision section 5 causes the condition acquisition section 3 to acquire all rules included in the decision tree. The condition decision section 5 calculates the holding probability of the output condition at each time with respect to all acquired rules, and finds an average of the holding probability at each time. The condition decision section 5 specifies time when the value becomes equal to the threshold or more, and sets a time zone before the specified time (including the specified time) as the time zone of unification common to the rules (step S112). Therefore, the condition decision section 5 uses this common time zone at the steps S85, S92 and S94 shown in FIG. 21.

According to the present embodiment, a minimum time zone satisfying predetermined precision is adopted as the time zone for unification, as heretofore described. Therefore, the processing can be executed by using a small quantity of calculation without lowering the precision much. Furthermore, according to the present embodiment, a time zone for unification common to the rules is calculated. Therefore, the processing efficiency can be further increased.

(Sixth Embodiment)

In fields of control or the like, there are a plurality of process outputs in many cases. There is a case where it is desirable to perform inverse calculation for a plurality of outputs. In other words, there is a case where it is desirable to find an input that makes a plurality of outputs simultaneously desirable values, for example, an input that makes the temperature of an apparatus and the pressure of another apparatus connected to the apparatus simultaneously desirable values.

As a first method, there is a method of converting a plurality of outputs to a one-dimensional evaluation value and constructing a model for the one-dimensional evaluation value. In the case where the evaluation value is one-dimensional, it is possible to construct a decision tree and execute inverse calculation by using the constructed decision tree.

In this method, however, a proper evaluation function for conversion to a one-dimensional evaluation value must be defined. The proper evaluation function differs depending upon the problem, and it is difficult to properly define the evaluation function. Even if an evaluation function can be defined properly, since conversion processing to the evaluation value exists for constructing a model, this method results in a problem of a prolonged calculation time.

As a second method, a method of regarding a direct product (set) of a plurality of outputs as a value of one object variable and constructing a model such as a decision tree is conceivable.

If in this method a loss (blank) is present in the value of the object variable in the observed data, then data of that portion cannot be used for construction of the decision tree. In other words, only data having complete values of all object variables can be used for constructing decision tree. Therefore, in this method, there is a fear that usable data will be remarkably limited. Fewer data used for construction exert a bad influence upon the precision of the generated decision tree, and there is also a fear that the decision tree will not be useful.

As a third method, there is a method of generating a plurality of decision trees with respect to each of a plurality of outputs and performing inverse calculation by using a plurality of decision trees simultaneously.

However, this method is difficult, or requires a long calculation time. The reason can be explained as follows. Even if a value of an explaining variable that makes certain one object variable desirable value is found by using certain one decision tree, the value of the explaining variable does not always satisfy the condition with respect to a different object variable.

In view of the problems heretofore described, the present inventors have gone through unique studies. As a result, the present inventors have acquired a technique of combining decision trees generated for respective object variables and generating a composite decision tree having a set of these object variables as an object variable. In other words, this composite decision tree has, in its leaf node, a value obtained by combining values of leaf nodes in decision trees. A condition required to simultaneously obtain a plurality of desirable outputs can be calculated by applying this composite decision tree to the first to fifth embodiments. Hereafter, the technique for combining the decision trees will be described in detail.

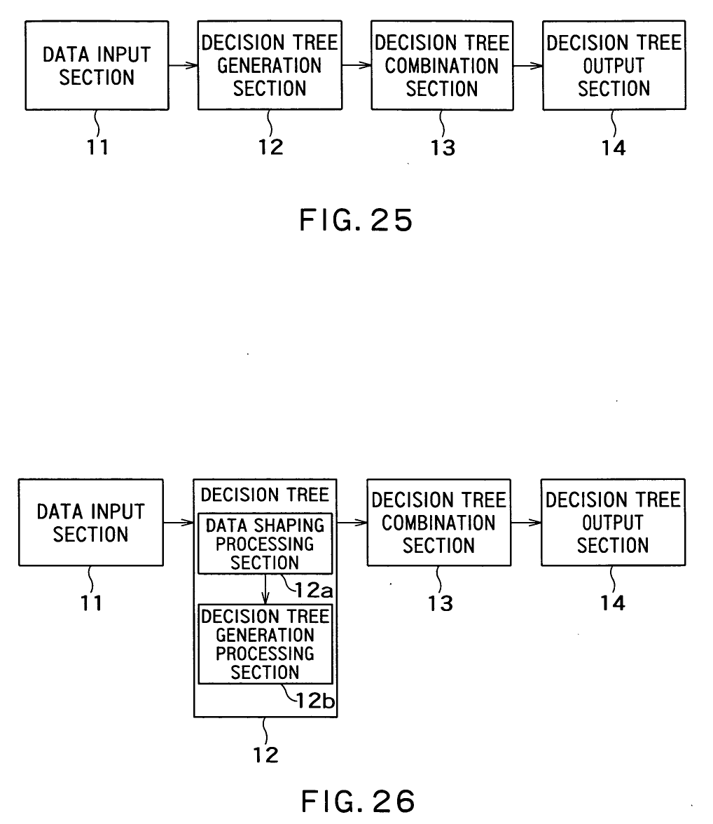

FIG. 25 is a configuration diagram of a decision tree combination apparatus, which combines a plurality of decision trees.

The decision tree combination apparatus includes a data input section 11, a decision tree generation section 12, a decision tree combination section 13, and a decision tree output section 14.

The data input section 11 inputs data including a value of an explaining variable and values of object variables to the decision tree generation section 12. The value of the explaining variable is, for example, an operation value inputted into a device. The values of the object variables are resultant outputs (such as the temperature and pressure) of the device. The present data includes a plurality of kinds of object variables. Typically, the data are collected by observation and recording (see FIG. 2).

The decision tree generation section 12 generates one decision tree on the basis of the value of the explaining variable included in the data and the value of one of object variables included in the data. The decision tree generation section 12 generates one decision tee for each of the object variables in the same way. In other words, the decision tree generation section 12 generates as many decision trees as the number of the object variables. Each decision tree has a value of an object variable at a leaf node (terminal node). Nodes other than leaf nodes become explaining variables. A branch that couples nodes becomes a value of an explaining variable.

The decision tree combination section 13 combines a plurality of decision trees generated in the decision tree generation section 12, and generates one decision tree (composite decision tree) that simultaneously infers values of a plurality of object variables on the basis of the value of the explaining variable. This composite decision tree has, at its leaf node, a set of values of object variables obtained by combining values of leaf nodes (values of object variables) in the decision trees. For example, assuming that a first decision tree has y1, y2, y3, . . . yn at respective leaf nodes and a second decision tree has z1, z2, z3, . . . zn at respective leaf nodes, leaf nodes of the combined decision tree become (y1,z1), (y1,z2) . . . (y1,zn), (y2,z1), (y2,z2), . . . (yn,zn). By using this composite decision tree as the object decision tree in the above-described first to fifth embodiments, a condition required to satisfy the values of a plurality of object variables simultaneously can be found. For example, when using this composite decision tree in the first embodiment and obtaining (y2,z1) as an output value at a given future, a condition required to obtain this value (y2,z1) can be found by specifying a leaf node having the value (y2,z1) and tracing branches from this leaf node toward the root node.

The decision tree output section 14 outputs the composite decision tree generated by the decision tree composite section 13. The outputted composite decision tree can be used as the object decision tree in the first to fifth embodiments. In other words, the condition acquisition section 3 shown in FIGS. 1 and 9 can use this composite decision tree as the object decision tree.

Hereafter, the apparatus shown in FIG. 25 will be described in detail by using a concrete example.

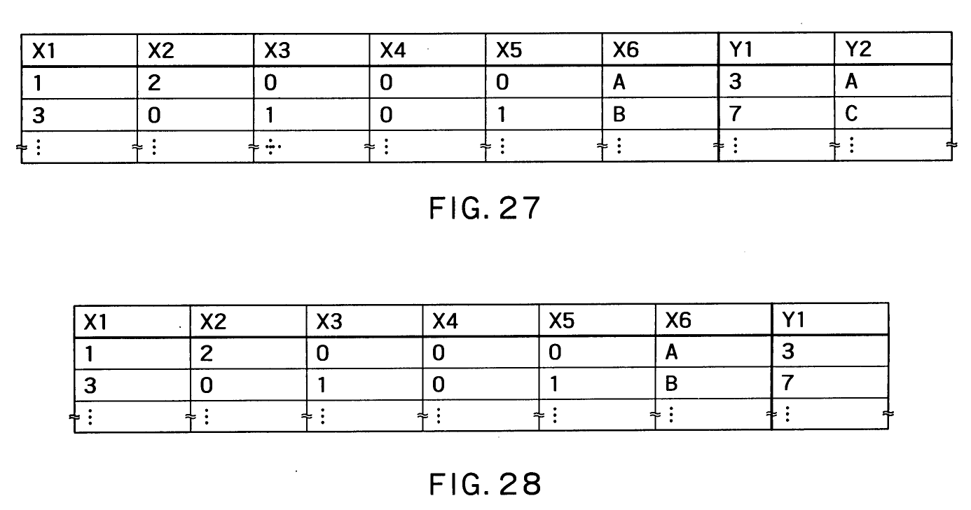

FIG. 27 is a table showing an example of observed data.

There are a large number of instances, such as an instance having 1 as the value of variable X1, 2 as the value of variable X2, 0 as the value of variable X3, 0 as the value of variable X4, 0 as the value of variable X5, A as the value of variable X6, 7 as the value of variable Y1 and A as the value of variable Y2, and an instance having 3 as the value of variable X1, 0 as the value of variable X2, 1 as the value of variable X3, 0 as the value of variable X4, 1 as the value of variable X5, B as the value of variable X6, 7 as the value of variable Y1 and C as the value of variable Y2. Here, X1 to X6 are explaining variables, and Y1 and Y2 are object variables. In the field of control, values of X1 to X6 correspond to the input into a target system (such as an item representing the material property and operation value of the device), and values of Y1 and Y2. correspond to the output from the target system (such as the temperature and pressure of a material).

First, data shown in FIG. 27 are inputted from the data input section 11 to the decision tree generation section 12. The inputted data are stored in a suitable form.

Subsequently, in the decision tree generation section 12, a decision tree is generated per object variable.

If data inputted from from the data input section 11 are the data shown in FIG. 27, then there are two object variables, and consequently two decision trees are generated. Data used to generate one decision tree (a decision tree associated with the object variable Y1) are shown in FIG. 28.

The data shown in FIG. 28 are obtained by deleting the data of the object variable Y2 and leaving the data of the object variable Y1 in the data shown in FIG. 27.

A method used to generate a decision tree on the basis of data thus including only one object variable is described in, for example, “Data analysis using AI” written by J. R. Quinian, translated by Yasukazu Furukawa, and published by Toppan Corporation in 1995, and “Applied binary tree analysis method” written by Atsushi Otaki, Yuji Horie and D.Steinberg and published by Nikks Giren in 1998.

In the same way, the decision tree associated with the object variable Y2 can also be generated. Data used to generate this decision tree are obtained by deleting the data of the object variable Y1 in the data shown in FIG. 27.

Decision trees generated for the object variables Y1 and Y2 as heretofore described are herein referred to as “decision tree 1” and “decision tree 2” for convenience.

Here, as shown in FIG. 26, which shows another example of the decision tree combination apparatus, it is also possible to divide the decision tree generation section 12 into a data shaping processing section 12a and a decision tree generation processing section 12b, cause the data shaping processing section 12a to generate data including only one object variable, and cause the decision tree generation processing section 12b to generate a decision tree by using the data. Decision trees associated with object variables may be generated in order or may be generated in parallel.

Although in generating a decision tree of each object variable, data including only one object variable has been generated temporarily (see FIG. 28), this processing is performed in order to simplify the description and therefore it may be omitted in the actual processing.

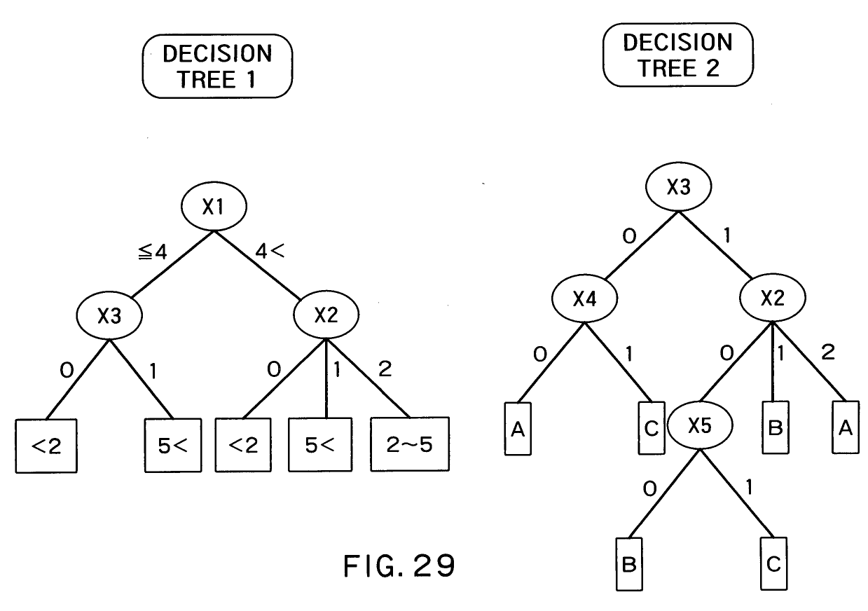

FIG. 29 is a diagram showing examples of the decision tree 1 and the decision tree 2 generated for the object variables Y1 and Y2.

Hereafter, how to see the decision tree 1 and the decision tree 2 will be explained briefly.

The decision tree 1 classifies the instance according to the value of Y1, which is an object variable (leaf node). First, it is determined whether X1 is greater than 4. If X1 is equal to 4 or less, then it is determined whether X3 is 0 or 1. If X3 is equal to 0, then Y1 is determined to be less than 2. If X3 is equal to 1, then Y1 is determined to be greater than 5. Also when X1 is greater than 4, similar processing performed. In FIG. 29, “2-5” in a leaf node means “between 2 and 5 inclusive of 2 and 5.”

In the same way, the decision tree 2 classifies the instance according to the value of Y2. First, it is determined whether X3 is 0 or 1. If X3 is 0, then it is determined whether X4 is 0 or 1. If X4 is 0, then Y2 is determined to be A. If X4 is 1, then Y2 is determined to be C. Also when X3 is 1, similar processing is performed.

These decision trees 1 and 2 classify instance sets included in already known data (see FIG. 27). Even for new data, however, values of Y1 and Y2, which are object variables, can be predicted.

Typically, classification using a decision tree is not right a hundred percent. Because there is a contradiction in data used to construct a decision tree, in some cases. Furthermore, because an instance that occurs only a few times is regarded as an error or noise and it does not exert an influence upon the construction of a decision tree in some cases. It is possible to generate a detailed decision tree that correctly classifies data obtained at the current time hundred percent, but actually such a decision tree is not so useful. Because it is considered that such a decision tree faithfully represents even noise and errors. In addition, such a decision tree merely re-represents the current data strictly, and necessity of re-representing the current data in a decision tree form is weak. Furthermore, because a decision tree that is too detailed becomes hard for the user to understand. Therefore, it is desirable to generate a compact decision tree with processing performed for noise moderately.

The decision tree combination section 13 combines a plurality of decision trees as described above and generates one decision tree. Hereafter, three kinds (combination methods 1 to 3) of concrete example of decision tree combination method will be described. However, it is also possible to use a combination of them.

Hereafter, the combination methods 1 to 3 will be described in order.

(Combination Method 1)

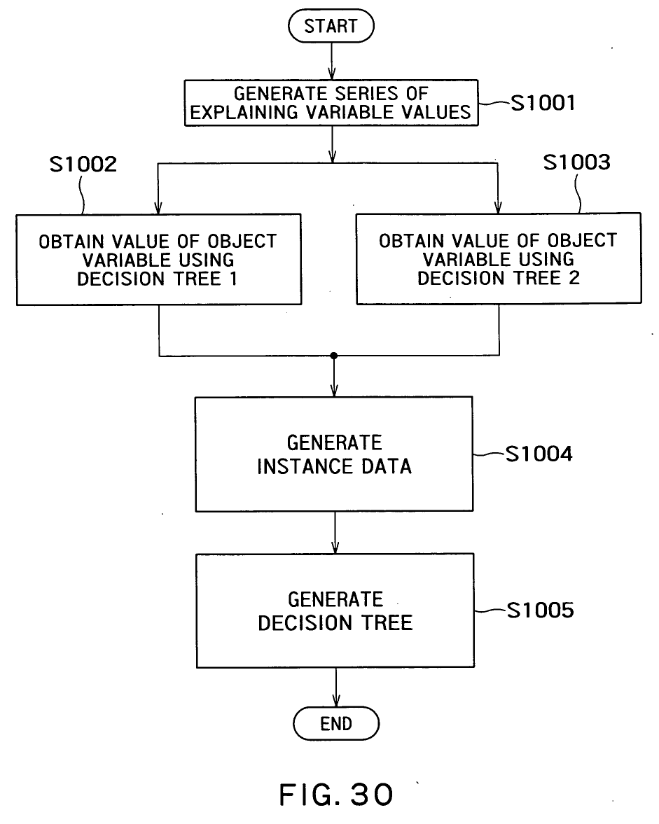

FIG. 30 is a flow chart showing a processing procedure for performing the combination method 1.

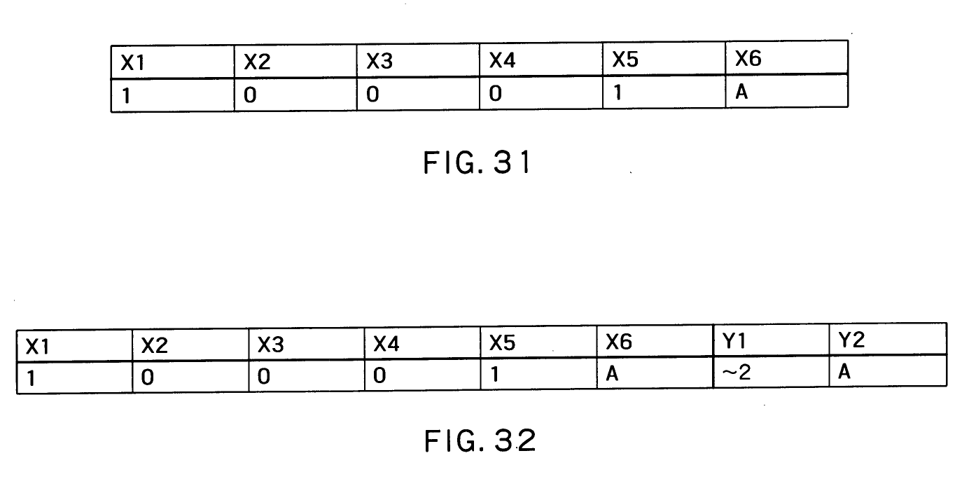

In the combination method 1, first, a series of values of explaining variables (explaining variable values) is generated (step S1001). The “series of explaining variable values” means, for example, input data having values of the explaining variables X1, X2, X3, X4, X5 and X6 shown in FIG. 27. First, one series is generated. It is now assumed that a series of explaining variable values shown in FIG. 31 has been generated.

Subsequently, the decision trees 1 and 2 are provided with the series of explaining variable values, and the value of the object variable is obtained (steps S1002 and S1003). In other words, a certain leaf node is arrived at by tracing a decision tree from its root node in order. The value of the leaf node is the value of the object variable.

Specifically, in the decision tree 1, X1 is 1, i.e., X1 is “<=4,” and consequently the processing proceeds to a left-side branch. Subsequently, since X3 is 0, the processing proceeds to a left-side branch. As a result, a leaf node of “<2” is arrived at. On the other hand, in the decision tree 2, X3 is 0, and consequently the processing proceeds to a left-side branch. Subsequently, since X4 is 0, the processing proceeds to a left-side branch. As a result, a leaf node of “A” is arrived at.

The values of the leaf nodes thus obtained from the decision trees 1 and 2 are added to the table shown in FIG. 31 to generate one instance (step S1004). FIG. 32 shows one generated instance data.

Subsequently, a different series of explaining variable values is generated. In this case as well, there are no constrain in how to generate the series, but it is desirable that the generated series is not the same as the series generated earlier. It is desirable to generate all combinations of explaining variable values by changing the values of explaining variables, for example, at random or in order. The series generated is given to the decision trees 1 and 2 to acquire the values of the object variables and obtain instance data. By repeating the above, a set of instance data is generated.

A decision tree is generated by using the set of generated instance data and regarding a set of two object variables as one object variable (step S1005). For example, a decision tree is generated by regarding “<2” and “A” in FIG. 32 as the value of one object variable. Since the decision tree generation method is described in the above-described document, here detailed description will be omitted.

(Combination Method 2)

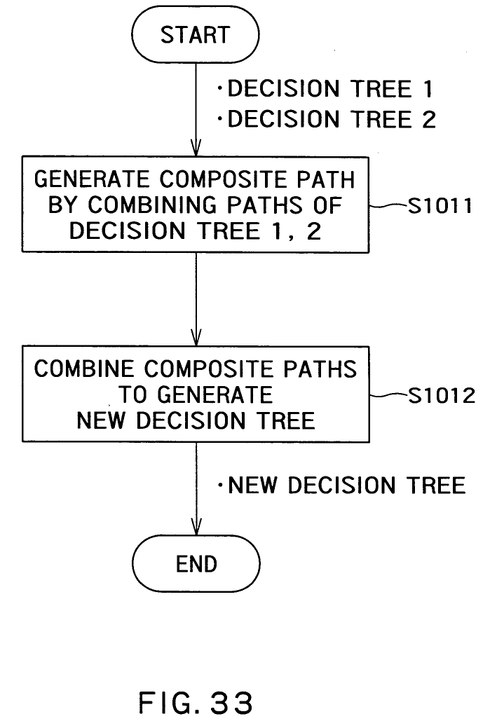

FIG. 33 is a flow chart showing a processing procedure for performing a combination method 2.

First, paths (rules) from the root node to leaf nodes are acquired from each of the decision trees 1 and 2, and all combinations of the acquired paths are generated. As a result, a plurality of path sets are generated. And by, for example, concatenating paths included in each path set, one new path (composite path) is generated from each path set, thereby, a new path set (a set of composite path) is obtained (step Subsequently, composite paths included in the new path set obtained at the step S1011 is combined to obtain one decision tree (step S1012).

Hereafter, the steps S1011 and S1012 will be described in more detail.

First, the step S1011 will be described.

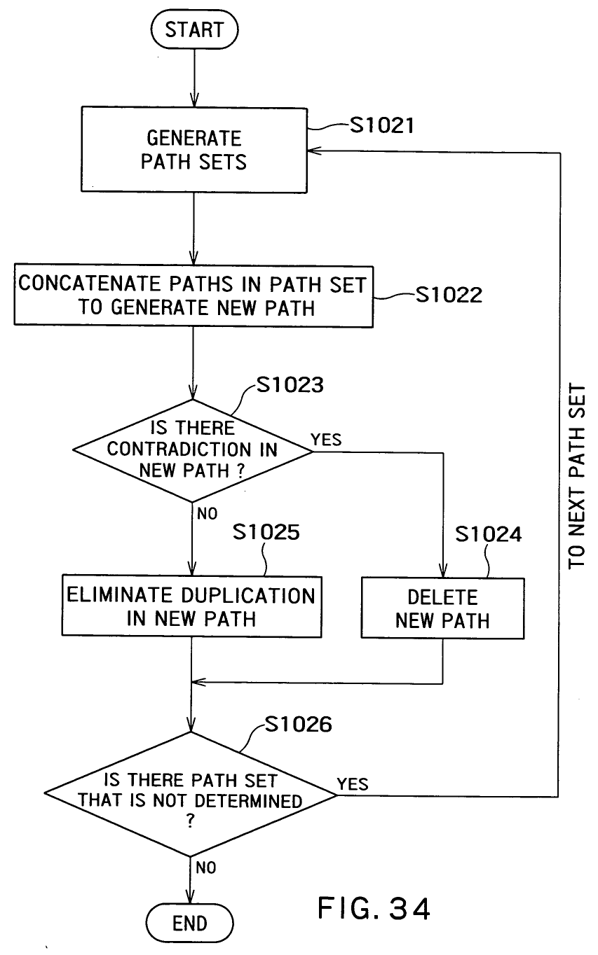

FIG. 34 is a flow chart showing a processing procedure at the step S1011.

First, paths from the root node to leaf nodes are acquired from each of the decision trees 1 and 2. The acquired paths are combined between the decision trees 1 and 2 in every kinds of combination, and a plurality of path sets are generated (step S1021).

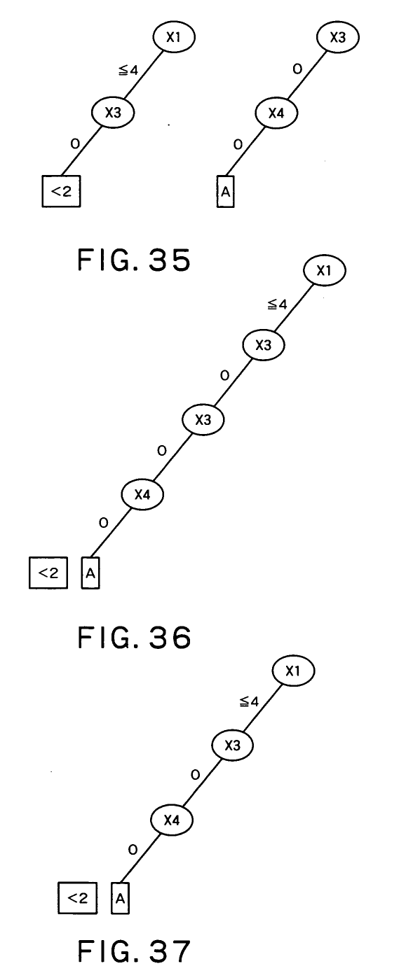

FIG. 35 is a diagram showing an example of a path set. The left side of FIG. 35 shows a path from the root node of the decision tree 1 (see FIG. 29) to the leftmost leaf node, and the right side of FIG. 35 shows a path from the root node of the decision tree 2 to the leftmost leaf node. Each path does not include branching.

Paths included in the decision tree 1 and paths included in the decision tree 2 are thus combined successively. It does not matter which order paths are combined in. However, all combinations are performed. Since the decision tree 1 has five leaf nodes and the decision tree 2 has six leaf nodes, (5×6=) 30 path sets are obtained.

Upon thus acquiring path sets, paths included in each path set are concatenated longitudinally to generate a new path (concatenated path) (step S1022 in FIG. 34).

FIG. 36 is a diagram showing a state in which the path set shown in FIG. 35 have been concatenated.

The leaf nodes (object variables) in paths before concatenation are assigned to an end of the concatenated path. Other nodes (explaining variables) are concatenated in the longitudinal direction. In FIG. 36, the path of the decision tree 2 is concatenated under the path of the decision tree 1. However, the path of the decision tree 1 may also be concatenated under the path of the decision tree 2.

Subsequently, it is checked whether there is a contradiction in the concatenated path (step 1023 in FIG. 34).

The “contradiction” means that there are duplicating explaining variables and their values are different from each other. For example, if two or more same explaining variables (nodes) are included in the concatenated path and one of them is 1 whereas the other is 0, then there is a contradiction.

If there is a contradiction (YES at the step S1023), then this concatenated path is deleted (step S1024), and the next path set is selected (YES at step S1026). In FIG. 36, there are two nodes X3. Since the two nodes X3 have the same value 0, there is no contradiction.

If there is no contradiction (NO at the step S1023), then processing for eliminating duplication included in the concatenated path is performed (step S1025). The “duplication” means that there are a plurality of same explaining variables (nodes) in the concatenated path and the explaining variables have the same value. The contradiction check has been performed at the step S1023. If there are a plurality of same explaining variables at the current time, therefore, the explaining variables should have the same value, and consequently there is duplication. If there is duplication, a duplicating explaining variable (node) and its branch are deleted from the concatenated path. As a result, the concatenated path becomes shorter. In FIG. 36, two nodes X3 are included in the concatenated path, and the two nodes X3 have a value of 0. Therefore, this is duplication. A path (composite path) obtained by eliminating the duplication from the concatenated path shown in FIG. 36 is shown in FIG. 37. The path generated by the step S1025 is referred to as “composite path”.

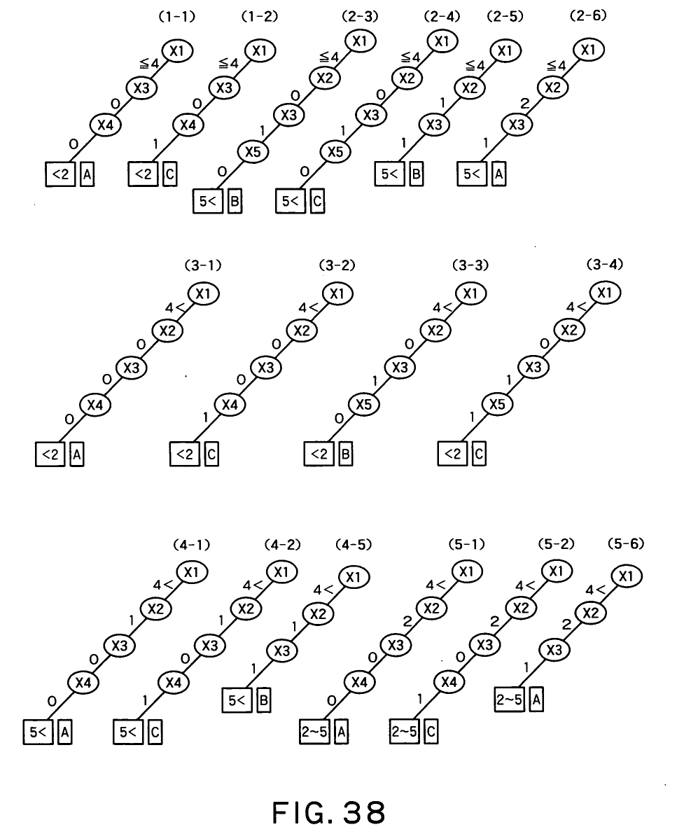

As heretofore described, the concatenation processing (the step S1022), the contradiction processing (the step S1024), and the duplication processing (the step S1025) are performed for each path set (30 path sets in the present example). Since contradicting concatenated paths are deleted by the contradiction processing (the step S1024), the number of generated composite paths becomes 30 or less. In the present example, 16 composite paths are generated. FIG. 38 shows 16 generated composite paths.

In FIG. 38, parenthesized numerical values indicated above each composite path represents how paths in the decision tree 1 and the decision tree 2 have been combined. For example, (1-2) means that a path including the leftmost leaf node in the decision tree 1 and a path including the second leftmost leaf node in the decision tree 2 have been combined. In FIG. 38, (1-3) and (1-4) are not present, because they have been deleted by the above-described contradiction processing (step S1024). In each composite path, nodes may be interchanged in arrangement order except the leaf nodes (object variables). In FIG. 38, nodes are arranged in the order of increasing number like X1, X2, . . . , for easiness to see.

Furthermore, the contradiction processing (the step S1024) and the duplication processing (the step S1025) may be inverted in execution order, or they may be executed in parallel. In this case as well, the same result is obtained.

The step S1012 (see FIG. 33) will now be described in detail.

At the step S1012, one decision tree is constructed by combining the composite paths (see FIG. 38) generated as heretofore described.

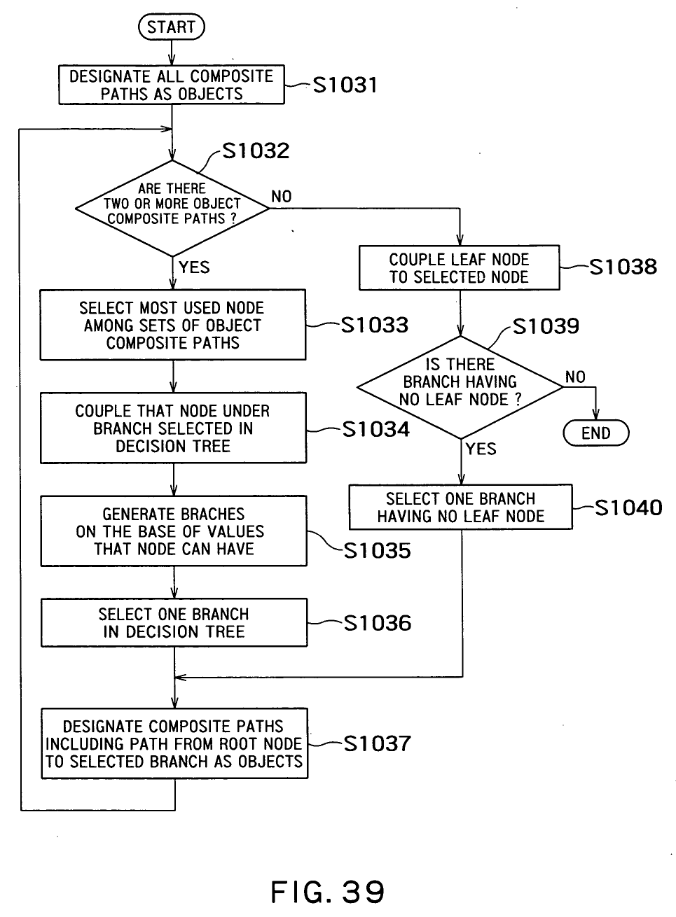

FIG. 39 is a flow chart showing the processing procedure at the step S1012 in detail.

First, all composite paths are handled as objects (step S1031). In the present example, 16 composite paths shown in FIG. 38 are handled as objects.

Subsequently, it is determined whether there are two or more object composite paths (step S1032). Since there are 16 object composite paths at the current time, the processing proceeds to “YES.”

Subsequently, an explaining variable (node) that is included most among the set of object composite paths is selected (step S1033). Upon checking 16 composite paths, it is found that the nodes X1 and X3 are used in all composite paths, and included most (respectively 16 times). If there are a plurality of most nodes, then arbitrary one node is selected. It is now assumed that the node X1 is selected. By the way, the composite paths shown in FIG. 38 are generated on the basis of the decision tree 1 and the decision tree 2. Therefore, each composite path necessarily includes the root nodes (the nodes X1 and X3 in the present example) of the decision trees 1 and 2.

Subsequently, the selected node is coupled under a branch selected in a new decision tree (the decision tree in the middle of generation), as a node of the new decision tree (step S1034). In first processing (a loop of the first time), however, the node is designated as a root node. At the current time, therefore, the node X1 is designated as the root node.

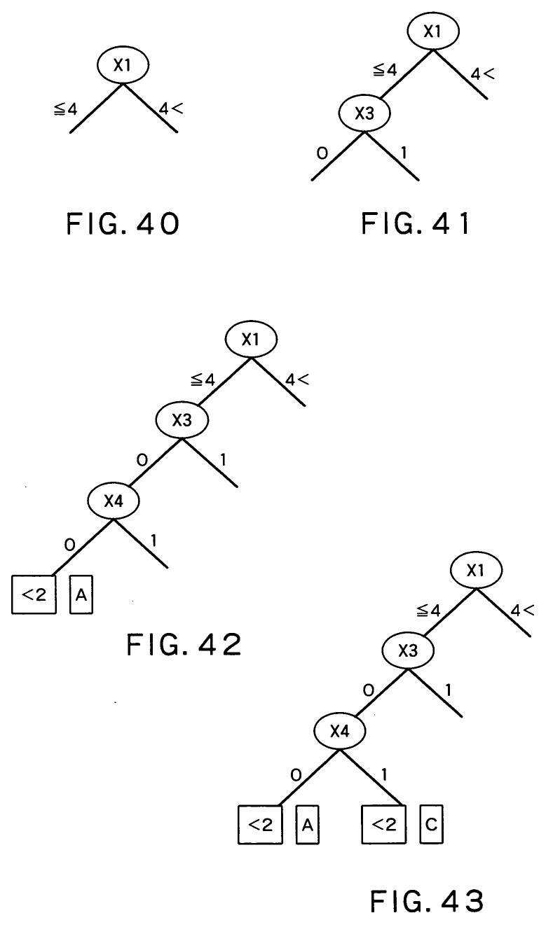

Branches are generated for the node on the basis of values that the node can have (step S1035). The values that the node can have are checked on the basis of a set of composite paths. Checking the values that the node X1 can have on the basis of the set of composite paths shown in FIG. 38, “<=4” and “4<” are obtained. Therefore, branches of “<=4” and “4<” are generated for the node X1. The decision tree in the middle of generation generated by processing heretofore described is shown in FIG. 40.

Subsequently, one branch is selected in the decision tree at the current time (step S1036). It is now assumed that the left-hand “<=4” branch has been selected in FIG. 40. The right-hand branch will be subject to processing later. Either branch may be selected earlier.

Subsequently, the set of composite paths shown in FIG. 38 is searched for composite paths including a path from the root node of this decision tree to the branch selected at the step 1036, and found paths are designated as object composite paths (step S1037). In the present example, composite paths including “X1<=4” are searched for, and the composite paths are designated as object composite paths. In the set of composite paths shown in FIG. 38, composite paths including “X1<=4” are six composite paths shown in the highest column. Therefore, these six composite paths are designated as object composite paths.

Returning back to the step S1032, it is determined whether there are two or more object composite paths. Since there are six object composite paths, the processing proceeds to “YES.”

Subsequently, a node that is included most among the set of object composite paths is selected (step S1033). Here, however, the node used to search for object composite paths at the step S1037 (the node X1 in the present example), i.e., the node on the path from the root node of the decision tree to the branch selected at the step S1036 is excluded. Since a node that is most included among the six composite paths shown in the highest column of FIG. 38 is X3, the node X3 is selected.

Subsequently, the selected node is coupled under the branch selected at the step S1036, as a node of the new decision tree (step S1034). Since the branch selected at the step S1036 is the left-hand branch shown in FIG. 40, the node X3 is coupled under the branch.

Branches are generated for the node on the basis of values that the coupled node can have (step S1035). Since the values that the node X3 can have are “0” and “1,” branches of “0” and “1” are generated under the node X3. The decision tree generated heretofore is shown in FIG. 41.

Subsequently, one branch is selected in the decision tree (step S1036). It is now assumed that the left-hand “0” branch has been selected from branches branched from the node X3.

Subsequently, the set of composite paths (six composite paths shown in the highest column) is searched for composite paths including a path from the root node of this decision tree to the branch selected at the step 1036, and found paths are designated as object composite paths (step S1037). The branch selected at the step S1036 is the left-hand “0” branch in branches branched from the node X3. Therefore, the six composite paths shown in the highest column are searched for composite paths including paths (“X1<=4” and “X3=0”) from the root node to that branch. Two composite paths, i.e., the leftmost composite path and the second leftmost composite path shown in the highest column of FIG. 38 are paths satisfying the above condition.

Returning back to the step S1032, it is determined whether there are two or more object composite paths. Since there are two object composite paths, the processing proceeds to “YES.”

Subsequently, a node that is included most among the set of object composite paths is selected (step S1033). However, the nodes X1 and X3 are excluded. Excluding the nodes X1 and X3, node included most in two object composite paths is the node X4, and consequently the node X4 is selected.

Subsequently, the selected node is coupled under the branch selected at the step S1036, as a node of the new decision tree (step S1034). Since the branch selected at the step S1036 is the left-hand branch (X3=0) shown in FIG. 41, the node X4 is coupled under the “0” branch branched from the node X3.

Branches are generated for the node on the basis of values that the coupled node can have (step S1035). The values that the node X4 can have are “0” and “1” respectively on the basis of the leftmost composite path and the second leftmost composite path shown in the highest column of FIG. 38. Therefore, branches corresponding to “0” and “1” are generated under the node X4 (see FIG. 42).

Subsequently, one branch is selected in the decision tree (step S1036). It is now assumed that the left-hand “0” branch has been selected from branches branched from the node X4.

Subsequently, the set of composite paths shown in FIG. 38 is searched for composite paths including a path from the root node of this decision tree to the branch selected at the step 1036, and found paths are designated as object composite paths (step S1037). The composite path that becomes the object is only the leftmost composite path in the highest column shown in FIG. 38.

Returning back to the step S1032, it is determined whether there are two or more object composite paths. Since there is only one object composite path, the processing proceeds to “NO.”

Subsequently, the leaf node in this composite path is coupled under the branch selected at the step S1036, and designated as a leaf node of the new decision tree (step S1038). In the present example, “<2, A” becomes the leaf node of the new decision tree. The decision tree generated heretofore is shown in FIG. 42.

Subsequently, it is determined whether there is a branch that is not provided with a leaf node in the decision tree (step S1039). Since there are three branches having no leaf nodes as shown in FIG. 42, the processing proceeds to “YES.”

Subsequently, one branch having no leaf node is selected in this decision tree (step S1040). It is now assumed that a branch of “X4=1” has been selected in the decision tree shown in FIG. 42. The selected branch may be any branch so long as it has no leaf node.

Subsequently, the processing proceeds to the step S1037. The set of composite paths shown in FIG. 38 is searched for a composite path including a path from the root node to the branch selected at the step S1040 in the decision tree at the current time, and the found composite path is designated as the object composite path. Here, only the second leftmost composite path in the highest column of FIG. 38 is designated as the object composite path.

Returning back to the step S1032, it is determined whether there are two or more object composite paths. Since there is only one object composite path, the processing proceeds to “NO.”

Subsequently, a leaf node in this composite path is coupled under the branch selected at the step 1040, and it is designated as a leaf node in the new decision tree. In the present example, “<2, C” becomes a leaf node in the new decision tree. The decision tree generated heretofore is shown in FIG. 43.

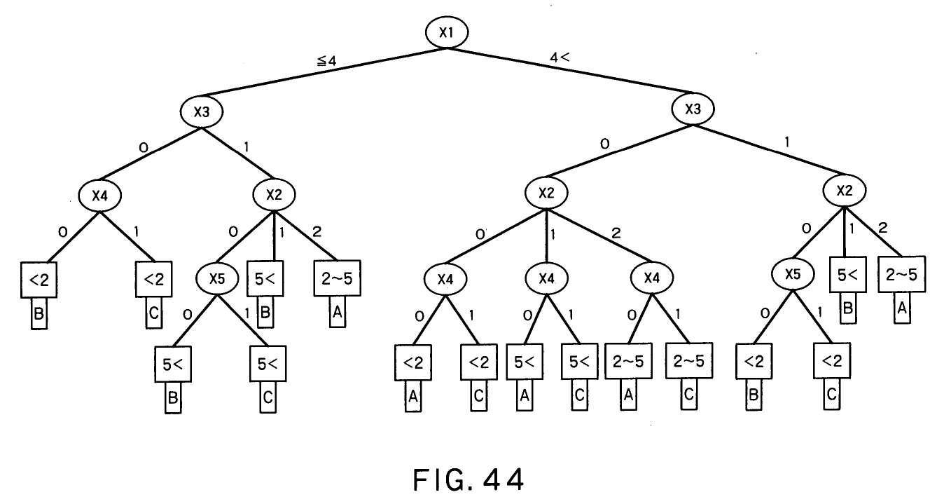

By continuing similar processing thereafter, a decision tree obtained by combining the decision tree 1 with the decision tree 2 is finally generated as shown in FIG. 44.

With reference to the step S1033 shown in FIG. 39, it has been described that any node may be selected if there are nodes having the same number, when finding a node that is included most in the set of object composite paths. There may be a doubt that the finally obtained decision trees may be different. However, finally obtained decision trees become equal in meaning. Because even if such a node is not selected at a certain time, the node is certainly selected at the next or subsequent selection opportunity. Since a leaf node of the new decision tree is generated on the basis of a combination of leaf nodes of both decision trees, contents of the finally obtained decision tree do not depend upon the order of node selection.

(Combination Method 3)

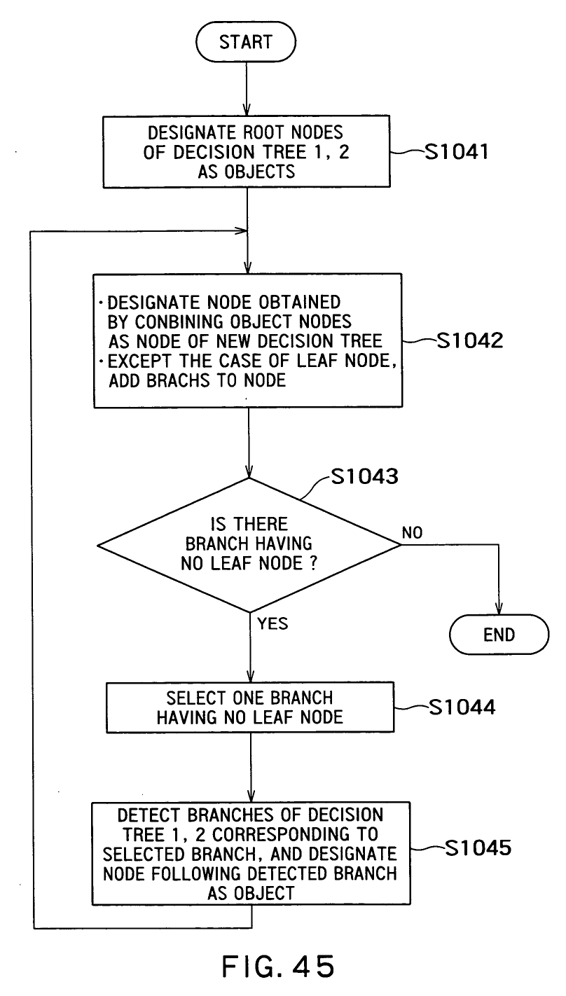

FIG. 45 is a flow chart showing a processing procedure for performing a combination method 3.

First, as represented by a step S1041, root nodes respectively of the decision tree 1 and the decision tree 2 are handled as objects. In the present example, the nodes X1 and X3 become objects (see FIG. 29).

Subsequently, object nodes are combined between different decision trees to generate a node set. The set of nodes are designated as node of a new decision tree (step S1042). In the present example, the set of the nodes X1 and X3 is designated as a node (set node) of the new decision tree. This node is referred to as “X1, X3”. Unless this set node is composed of a leaf node, a node corresponding to this set node is detected from each decision tree, and branches of detected nodes are combined to generate a new branch. The generated new branch is added to the set node. In the present example, nodes corresponding to the node “X1, X3” in the decision tree 1 and the decision tree 2 are X1 and X3. Therefore, branches of the nodes X1 and X3 are combined to generate a new branch.

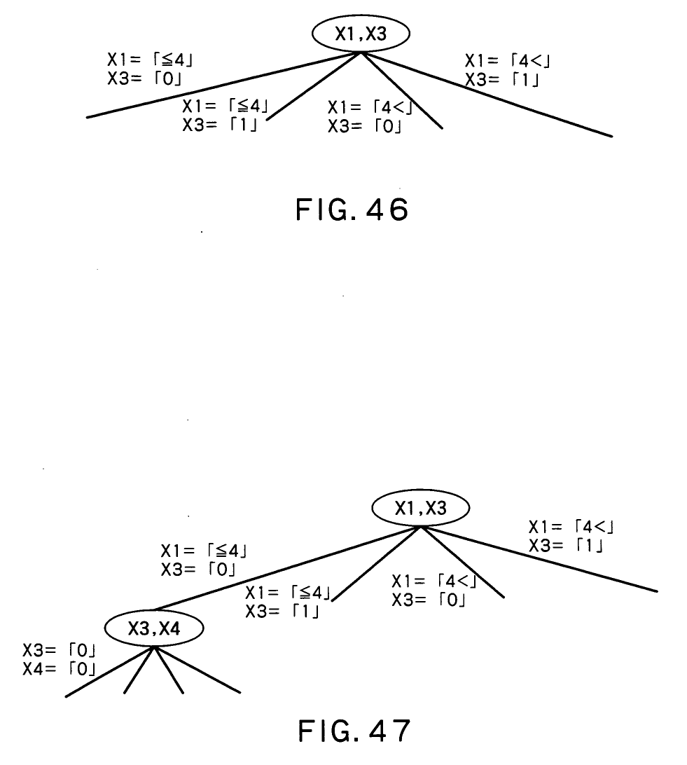

For more detail, the node X1 in the decision tree 1 has branches of “<=4” and “4<”, and the node X3 in the decision tree 2 has branches of “0” and “1.” Therefore, four new branches of “<=4, 0”, “<=4, 1”, “4<, 0” and “4<, 1” are generated and added to the node “X1, X3.” The decision tree in the middle of generation generated heretofore is shown in FIG. 46.

Subsequently, it is determined whether there is a branch having no leaf node (step S1043). As shown in FIG. 46, there are four branches having no leaf node, and consequently the processing proceeds to “YES.”

Subsequently, one branch having no leaf node is selected (step S1044). It is now assumed that the leftmost branch has been selected. However, the selected branch may be any branch.

Subsequently, a branch of the decision tree 1 and a branch of the decision tree 2 corresponding to the selected branch are detected, and a node following this branch is selected as an object (step S1045). As described above, the selected branch is the leftmost branch shown in FIG. 46, i.e., a branch of “X1<=4, X3=0.” Therefore, a branch “X1<=4” in the decision tree 1 corresponding to the branch of “X1<=4, X3=0” is traced, and the next node X3 is selected. In the same way, a branch “X3=0” in the decision tree 2 corresponding to the branch of “X1<=4, X3=0” is traced, and the next node X4 is selected. These nodes are designated as objects.

Returning back to the step S1042, nodes designated as the objects are combined to generate a new node. This new node is added to the new decision tree. In the present example, the nodes designated as the objects are X3 and X4. In FIG. 46, therefore, a node “X3, X4” is added under the leftmost branch. In the same way as the foregoing description, branches are branched from that node “X3, X4”. As a result, branches of four kinds, i.e., branches of “0, 0”, “0, 1”, “1, 0” and “1, 1” are added (step S1042). The decision tree heretofore generated is shown in FIG. 47. Due to the restriction imposed on paper, only the leftmost branch, among branches branched from the node “X3, X4” is provided with values.

Subsequently, it is determined whether there is a branch having no leaf node in the decision tree at the current time (step S1043). Since any branch is not yet provided with a leaf node, the processing proceeds to “YES.”

Subsequently, one branch having no leaf node is selected (step S1044). It is now assumed that the leftmost branch has been selected.

Subsequently, a branch of the decision tree 1 and a branch of the decision tree 2 corresponding to the selected branch are specified, and a node following this branch is selected as the object (step S1045). In the present example, the leftmost branch in FIG. 47 has been selected. Therefore, a node “<2” following a branch “X3=0” in the decision tree 1 corresponding to the leftmost branch in FIG. 47, and a node “A” following a branch “X4=0” in the decision tree 2 corresponding to the leftmost branch in FIG. 47 are selected.

Returning back to the step S1042, nodes designated as the objects are combined to generate a new node. This new node is added to the new decision tree (step S1042). In the present example, a node “<2, A” is added as a new node. Since the nodes “<2” and “A” are leaf nodes in the decision tree 1 and the decision tree 2, however, the newly generated node “<2, A” becomes a leaf node in the new decision tree. Therefore, branched branches are not generated from the node “<2, A.” If at this time one of the nodes is a leaf node in the original decision tree, whereas the other of the nodes is not a leaf node, then branched branches are further generated by using the decision tree including the node that is not a leaf node, in the same way as the foregoing description.

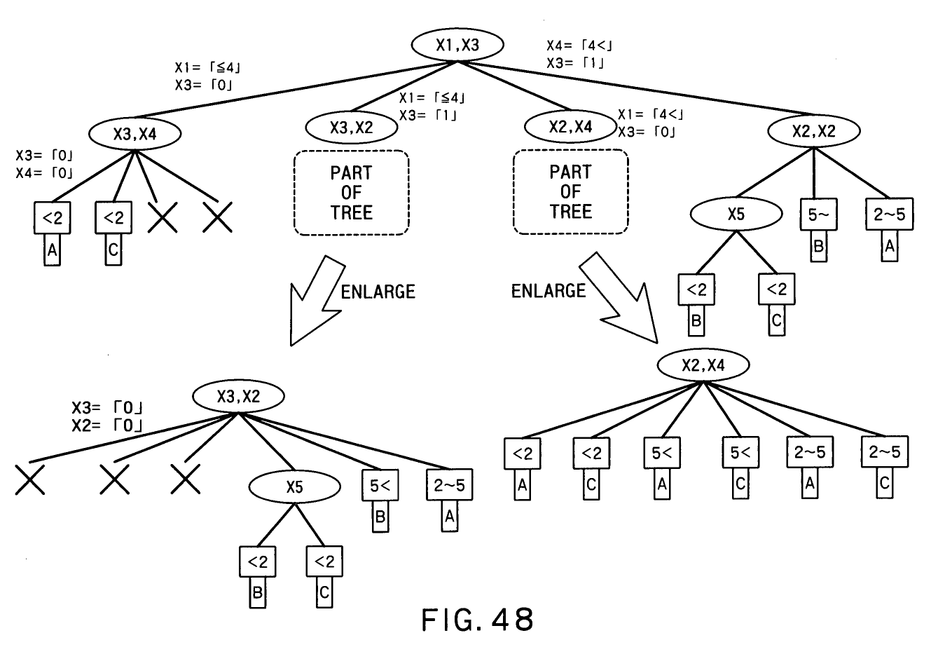

By repeating the processing heretofore described, a decision tree shown in FIG. 48 is finally generated.

In FIG. 48, parts of the tree are enlarged and shown in different places due to the restriction on the paper space. In FIG. 48, a path provided with a mark “X” is not actually present because there is a contradiction, but it is shown in order to express clearly the fact.

Heretofore, the combination methods 1, 2 and 3 have been described. The combination method 2 and the combination method 3 produce decision trees that are equal in meaning. It is a possibility that the combination method 1 will produce a decision tree that is slightly different from that produced by the combination method 2 and the combination method 3, depending upon given data. If the number of data is large, however, there is no great difference.

An improvement method for the decision tree generated as heretofore described will now be described below.

Typically, a decision tree has not only information concerning the branches and nodes, but also various data calculated to construct the decision tree from observed data. Specifically, the decision tree has the number of instances in each explaining variable (node) (for example, when a certain explaining variable can has “0” and “1” as its value, the number of instances in the case of “0” and the number of instances in the case of “1”), and distribution of the number of instances in each explaining variable with respect to the value of an object variable (for example, when there are 100 instances in which a certain explaining variable becomes “0” in value, there are 40 instances in which the object variable becomes A in value and 60 instances in which the object variable becomes B in value). By using these kinds of information hold by the decision tree, therefore, a composite decision tree generated by using one of the combination methods 1 to 3 is evaluated, and the composite decision tree is improved by deleting paths having low precision.

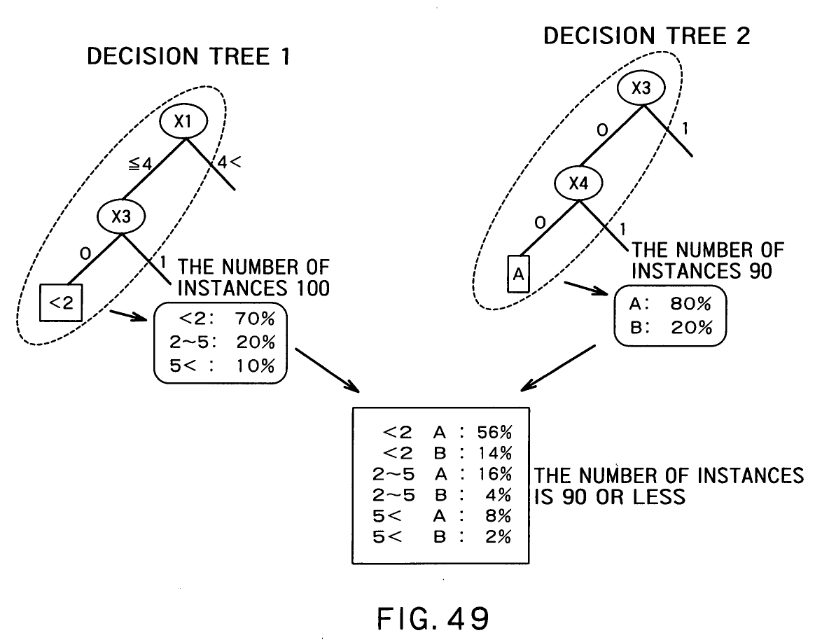

FIG. 49 is a diagram showing an evaluation method of a leftmost path in the composite decision tree (see FIG. 48). The leftmost path in FIG. 4 is a path generated by combining leftmost paths respectively in the decision tree 1 and the decision tree 2.

The left side of FIG. 49 shows the leftmost path of the decision tree 1. There are 100 instances satisfying “X1<=4” and “X3=0”. There are 70 instances in which the value of the object variable becomes “<2”, 20 instances in which the value of the object variable becomes “2-5” (between 2 and 5 inclusive 2 and 5), and 10 instances in which the value of the object variable becomes “5<”. In other words, the precision of the path in the decision tree 1 is 70% (70/100).

The right side of FIG. 49 shows the leftmost path of the decision tree 2. There are 90 instances satisfying “X3=0” and “X4=0”. There are 80 instances in which the value of the object variable becomes “A”, and 20 instances in which the value of the object variable becomes “B”. In other words, the precision of the path in the decision tree 2 is 80% (80/100).

When “X1<=4” and “X3=0” and “X4=0”, therefore, it is inferred that the probability of the value of the object variable becoming “<2, A” is 70%×80%=56%.

By the way, it is impossible that the number of instances in the composite decision tree becomes greater than the number of instances in the original decision tree. Therefore, the number of instances in the composite decision tree becomes at most, min{the number of instances in the composite decision tree 1, the number of instances in the composite decision tree 2}. In the present example, the number of instances in the composite decision tree becomes 90 or less as shown in FIG. 49.

On the basis of this, in the composite decision tree, when “X1<=4” and “X3=0” and “X4=0”, it is inferred that the number of instances in which the value of the object variable becomes “<2, A” is at most 90×56%=approximately 50. If this value or probability is equal to a predetermined value or less, then the composite decision tree is improved by deleting.

Furthermore, it is also possible to apply each path (rule corresponding to each path) of the composite decision tree to already known observed data, find the number of instances (or probability) satisfying the rule, find its average, and thereby evaluate the whole composite decision tree. Besides, it is also possible to estimate the stochastically most probable number of instances and distribution.

Heretofore, an embodiment of the present invention has been described. The scope of the present invention is not restricted to the case where the explaining variables are the same with respect to object variables or decision trees. In other words, in the foregoing description, the case where the explaining variables are the same for respective object variables as shown in FIG. 27 has been handled for brevity. However, the present invention can also be applied to the case where, for example, explaining variables for Y1 are different from explaining variables for Y2.

If there are no duplications at all in explaining variables, however, the present invention can be applied, but the necessity of application is considered to be low. One of objects of the present invention is to implement inverse calculation for finding values of explaining variables that make a plurality of object variables desirable values. If explaining variables for object variables are completely different, there is no difference in processing contents irrespective of whether inverse calculations are performed independently using individual decision tree without combining the decision trees, or whether the decision trees are combined and then inverse calculation is performed. On the other hand, if there are partial duplications in explaining variables, the effect of the present embodiment is obtained.

Furthermore, in the present embodiment, an example in which two decision trees are combined has been described for brevity. Even if there are three or more decision trees, however, the present invention can be applied.

The above-described decision tree combination apparatus can be constructed by hardware. As a matter of course, however, the equivalent function can also be implemented by using a program.

Heretofore, the decision tree combination method and the decision tree improvement method have been described. Typically, the following advantages can be obtained by generation of the decision tree and data analysis using the decision tree.

Generalization of the model and knowledge is facilitated by generating a decision tree from observed data. If a continuous value is used as a value of a variable, there is an advantage that moderate discrete is performed. In addition, since explaining variables that exert an influence upon the object variable, i.e., important explaining variables are automatically extracted when generating a decision tree, important explaining variables can be found. For example, in the data shown in FIG. 27, there is an explaining variable X6. However, the explaining variable X6 is not present in the decision tree 1 and the decision tree 2. Therefore, it can be the that the explaining variable X6 is not important. The decision tree is an effective model also in a sense that it provides the user with knowledge concerning data. Furthermore, the decision tree can cope with unknown data preferably while preventing excessive conformity to already known data.

According to the present embodiment, a plurality of decision trees are combined to generate a decision tree, which infers values of a plurality of object variables simultaneously on the basis of values of explaining variables, as heretofore described. By using this decision tree as an object decision tree in the first to fifth embodiments, therefore, inverse calculation for finding a condition to make a plurality of object variables simultaneously desirable values can be performed simple. If the combination method 1 is used as the decision tree combination method, then it suffices to add simple post-processing (a simple program) after generation of decision trees respectively for object variables, and consequently the processing is easy. In the combination method 2, a concise (easy to see) decision tree can be generated. In the combination method 3, a decision tree that is easy to understand correspondence to the original decisional tree can be generated, and the algorithm is also simple.

According to the present embodiment, a model with high precision can be constructed even if a loss value (a loss value of an object variable) is included in observed data. In the method of constructing a decision tree by regarding a direct product of object variables as one object variable (the second method described at the beginning of the present embodiment), there is a problem that if there is a loss value of an object variable in observed data the data of that portion cannot be used for construction of a decision tree and the precision of the constructed model falls. On the other hand, in the present embodiment, a decision tree for each object variable is first constructed. Thereafter, a composite decision tree is generated by combining the decision trees. In the present embodiment, therefore, a model (composite decision tree) with high precision can be constructed even if there is a loss value of an object variable in observed data.

1. An inverse model calculation apparatus for finding a condition under which a target system outputs a certain output value, the target system outputting the certain output value on the basis of an input value to the target system, the inverse model calculation apparatus comprising:
a time series data recording section which records an input value inputted sequentially to the target system and an output value outputted sequentially from the target system as time series data;
a decision tree generation section which generates a decision tree for inferring an output value at future time, using the time series data; and
a condition acquisition section which detects a leaf node having an output value at future time as a value of an object variable from the decision tree, and acquires a condition of explaining variables included in a rule associated with a path from a root node of the decision tree to the detected leaf node, as a condition for obtaining the output value.

2. The inverse model calculation apparatus according to claim 1, wherein
the target system outputs the output values of a plurality of items in response to the inputted input value, and the time series data recording section records the sequentially inputted input value and the sequentially outputted output values of the plurality of items as the time series data,
the decision tree generation section generates the decision tree regarding the item as object variable for every item, using the time series data,
the inverse model calculation apparatus further comprises a decision tree combination section combining the decision trees generated for the items to generate a composite decision tree having a set of object variables of the decision trees as one object variable, and
the condition acquisition section detects a leaf node having output values of the plurality of items at future time as a value of an object variable from the composite decision tree, and acquires a condition of explaining variables included in a rule associated with a path from a root node of the composite decision tree to the detected leaf node, as a condition for obtaining the output values of the items.

3. The inverse model calculation apparatus according to claim 2, wherein the decision tree combination section comprises:
a first processing section which implements inputting values of explaining variables to the decision trees and obtaining a value of a object variable from the decision trees respectively, a plurality of times; and
a second processing section which regards a set of values of the object variables obtained from the decision trees each time, as a value of one item, and which generates a decision tree having the one item as an object variable by using the values of explaining variables inputted to the decision trees and the values of object variables obtained from the decision trees.

4. The inverse model calculation apparatus according to claim 2, wherein the decision tree combination section comprises:
a root node decision section which acquires paths from a root node to leaf nodes from each of the decision trees, which generates a plurality of path sets by combining paths acquired from the decision trees between different decision trees, and which determines a node other than leaf nodes, that is most included in the plurality of path sets, as a root node of the composite decision tree;
a root node value decision section which specifies values for the determined root node, on the basis of the path sets including the determined root node, and which adds branches having the specified values to the determined root node;
a path set detection section which selects the branch added to the root node, and which detects path sets having the root node and the selected branch from among the path sets including the determined root node;
a node detection section which detects a node other than leaf nodes, that is most included except the root node in the detected path sets and add the detected node to the selected branch; and
a node value decision section which specifies a value for the detected node, using the detected path sets including the node detected by the node detection section, and which adds a branch having the specified value to the detected node; wherein
the path set detection section selects the branch added by the node value decision section, and detects the path set having nodes and branches included in a path from the root node to the selected branch,
in the case where the number of the detected path set is at least 2,
the node detection section detects a node other than leaf node, that is most included except nodes included in the path from the root node to the selected branch, from the detected path sets and adds the detected node to the selected branch,
the node value decision section specifies a value for the detected node, using the detected path sets including the detected node, and adds a branch having the specified value to the detected node,
the path set detection section selects the added branch, and detects the path set having nodes and branches included in a path from the root node to the selected branch,
in the case where the number of the detected path set is less than 2,
the node detection section adds a node having a set of values of leaf nodes included in the detected path set to the selected branch as a leaf node of the composite decision tree,
the path set detection section selects a branch having no leaf node from the composite decision tree in the middle of generation in the case where there is a branch having no leaf node, and detects the path set having nodes and branches included in a path from the root node to the selected branch.

5. The inverse model calculation apparatus according to claim 2, wherein the decision tree combination section comprises:
a root node generation section which generates a composite node that is a set of root nodes in the decision trees, as a root node of the composite decision tree;
a root node value generation section which detects values that the root nodes in the decision trees have respectively, which generates a node value sets by combining the detected values between different decision trees, and which adds branches having the node value sets to the generated root node;
a node generation section which selects the added branch, which generates a set of nodes other than leaf nodes, following branches of the decision trees corresponding to the selected branch, as a composite node, in the case whether nodes other than leaf nodes are included in nodes following branches of the decision trees corresponding to the selected branch, and which adds this composite node to the selected branch;
a node value generation section which detects values that nodes constituting the composite node have on the base of the decision trees, which generates a node value set by combining the detected values between different decision trees, and which adds a branch having the node value set to the composite node:
a leaf node generation section which selects the added branch, which specifies paths in the decision trees corresponding to a path from the root node generated by the root node generation section to the selected branch, in the case where nodes other than leaf nodes are not included in nodes following branches of the decision trees corresponding to the selected branch, and which adds a node including a set of values of leaf nodes in the specified paths, to the selected branch as a leaf node of the composite decision tree.

6. The inverse model calculation apparatus according to claim 2, wherein the decision tree combination section further comprises:
a calculation section which selects a path from a root node to a leaf node from the composite decision tree, which detects paths corresponding to the selected path from the decision trees, and which calculates a probability that rules associated with the detected paths hold;
an inference section which infers a probability that rule associated with the selected path hold, on the basis of holding probabilities of the rules; and
a deletion section which deletes the selected path from the composite decision tree in the case where the inferred probability does not satisfy a predetermined reference.

7. The inverse model calculation apparatus according to claim 1, further comprising:
an input value generation section which generates an input value inputted to the target system, in the case where the condition acquired by the condition acquisition section is an input condition at future time, on the base of the input condition.

8. An inverse model calculation apparatus for finding a condition under which a target system outputs a certain output value, the target system outputting the certain output value on the basis of an input value to the target system, the inverse model calculation apparatus comprising:
a time series data recording section which records an input value inputted sequentially to the target system and an output value outputted sequentially from the target system as time series data;
a decision tree generation section which generates a decision tree for inferring an output value at future time, using the time series data;
a condition acquisition section which an output value at future time is inputted into as a initial condition, which detects a leaf node having the inputted output value as a value of an object variable from the decision tree, and which acquires a condition of explaining variables included in a rule associated with a path from a root node of the decision tree to the detected leaf node, as a condition to obtain the output value; and
a condition decision section, which determines whether the acquired condition is a past condition or a future condition, which determines whether the acquired condition is true or false by using the time series data and the acquired condition in the case where the acquired condition is the past condition, which determines whether the acquired condition is an input condition or an output condition in the case where the acquired condition is the future condition, which outputs the acquired condition as a necessary condition for obtaining the output value in the case where the acquired condition is the input condition, and which outputs the acquired condition to the condition acquisition section as an output value at future time in the case where the acquired condition is the output condition.

9. The inverse model calculation apparatus according to claim 8, wherein the condition decision section increments the future time and outputs the output value at the incremented future time to the condition acquisition section, in the case where the acquired condition is false.

10. An inverse model calculation apparatus for finding a condition under which a target system outputs a certain output value, the target system outputting the certain output value on the basis of an input value to the target system, the inverse model calculation apparatus comprising:
a time series data recording section which records an input value inputted sequentially to the target system and an output value outputted sequentially from the target system as time series data;
a decision tree generation section which generates a decision tree for inferring an output value at future time, using the time series data, a path from a root node to a leaf node being associated in the decision tree with a rule including a condition of explaining variables and a value of an object variable;
a first rule detection section which detects a rule having an output value at future time as a value of an object variable, from the decision tree;
a first condition calculation section which determines whether a condition of explaining variables for a partial time zone in the detected rule matches the time series data, and which in the case of matching, calculates a condition for obtaining the output value at the future time, using the detected rule and the time series data;
a second rule detection section, to which a rule is inputted, and which detects a rule that a condition of explaining variables for a partial time zone in the inputted rule matches from the decision tree;
a first input section which inputs the rule detected by the first rule detection section to the second rule detection section, in the case where the rule detected by the first rule detection section does not match the time series data;
a second input section which determines whether a condition of explaining variables for a partial time zone in the rule detected by the second rule detection section matches the time series data, and which, in the case of not-matching, inputs the rule detected by the second rule detection section to the second rule detection section; and
a second condition calculation section which calculates a condition for obtaining the output value at the future time, using all rules detected by the first and second rule detection sections and the time series data, in the case where the rule detected by the second rule detection section matches the time series data.

11. The inverse model calculation apparatus according to claim 10, further comprising:
a probability calculation section which calculates a probability that an output condition at certain time included in the rule detected by at least one of the first and second rule detection sections holds in the case where other condition before the certain time and at the certain time has held;
a time determination section which determines the certain time such that the probability satisfies a predetermined threshold; and
a time zone determination section which determines a time zone, including a time zone before the determined time and the determined time, as the partial time zone of the rule.

12. The inverse model calculation apparatus according to claim 10, further comprising:
an average calculation section which calculates, with respect to each rule of rules included in the decision tree, a probability that an output condition at certain time holds in the case where other condition before the certain time and at the certain time has held, and which calculates an average of the calculated probability between the rules;
a time determination section which determines the certain time such that the average of the probability satisfies a predetermined threshold; and
a common time zone determination section which determines a time zone that includes a time zone before the determined time and the determined time, as the partial time zone to be commonly applied to the rules.

13. An inverse model calculation method for finding a condition under which a target system outputs a certain output value, the target system outputting the certain output value on the basis of an input value to the target system, the inverse model calculation method comprising:
recording an input value inputted sequentially to the target system and an output value outputted sequentially from the target system as time series data;
generating a decision tree for inferring an output value at future time, using the time series data; and
detecting a leaf node having an output value at future time as a value of an object variable from the decision tree; and
acquiring a condition of explaining variables included in a rule associated with a path from a root node of the decision tree to the detected leaf node, as a condition for obtaining the output value.

14. An inverse model calculation method for finding a condition under which a target system outputs a certain output value, the target system outputting the certain output value on the basis of an input value to the target system, the inverse model calculation apparatus comprising:
recording an input value inputted sequentially to the target system and an output value outputted sequentially from the target system as time series data;
generating a decision tree for inferring an output value at future time, using the time series data;
inputting an output value at future time as a initial condition;
detecting a leaf node having the inputted output value as a value of an object variable from the decision tree;
acquiring a condition of explaining variables included in a rule associated with a path from a root node of the decision tree to the detected leaf node, as a condition for obtaining the output value;
determining whether the acquired condition is a past condition or a future condition;
determining whether the acquired condition is true or false by using the time series data and the acquired condition in the case where the acquired condition is the past condition;
determining whether the acquired condition is an input condition or an output condition in the case where the acquired condition is the future condition;
outputting the acquired condition as a necessary condition for obtaining the output value in the case where the acquired condition is the input condition
regarding the acquired condition as an output value at future time in the case where the acquired condition is an output condition, and detecting a leaf node having the regarded output value at the future time as a value of an object variable from the decision tree,
acquiring a condition of explaining variables included in a rule associated with a path from the root node to the detected leaf node, as a condition for obtaining the regarded output value.

15. The inverse model calculation method according to claim 14, further comprising:
incrementing the future time in the case where the acquired condition is false;
inputting the output value at the incremented future time as a new initial condition.

16. An inverse model calculation method for finding a condition under which a target system outputs a certain output value, the target system outputting the certain output value on the basis of an input value to the target system, the inverse model calculation method comprising:
recording an input value inputted sequentially to the target system and an output value outputted sequentially from the target system as time series data;
generating a decision tree for inferring an output value at future time, using the time series data, a path from a root node to a leaf node being associated in the decision tree with a rule including a condition of explaining variables and a value of an object variable;
detecting a rule having an output value at future time as a value of an object variable, from the decision tree;
in the case where a condition of explaining variables for a partial time zone in the detected rule matches the time series data, calculating a condition for obtaining the output value at the future time, using the detected rule and the time series data;
in the case of non-matching, newly detecting a rule matching the condition of explaining variables for a partial time zone in the detected rule, from the decision tree;
in the case where a condition of explaining variables for a partial time zone in the newly detected rule does not match the time series data, further detecting a rule which the condition of explaining variables for a partial time zone in the newly detected rule matches, from the decision tree;
repeating detecting a rule which a condition of explaining variables for a partial time zone in a latest detected rule matches, from the decision tree, until a rule whose condition of explaining variables for a partial time zone matches the time series data is detected; and
calculating a condition required to obtain the output value at the future time by using all rules detected from the decision tree and the time series data, in the case where the rule whose condition of explaining variables for a partial time zone matches the time series data has been detected.
